(19) United States
(12) Patent Application Publication
(10) Pub. No.: US 2011/0277474 A1
(43) Pub. Date: Nov. 17, 2011

(54) METHODS AND SYSTEMS USING NATURAL GAS POWER PLANT

(76) Inventors: BRENT R. CONSTANTZ, Portola Valley, CA (US); Ryan J. Gilliam, San Jose, CA (US)

(21) Appl. No.: 13/157,654

(22) Filed: Jun. 10, 2011

Related U.S. Application Data
(63) Continuation-in-part of application No. 12/698,741, filed on Feb. 2, 2010.
(60) Provisional application No. 61/360,397, filed on Jun. 30, 2010.
(60) Provisional application No. 61/479,153, filed on Apr. 26, 2011.
(60) Provisional application No. 61/441,194, filed on Feb. 9, 2011.
(60) Provisional application No. 61/443,607, filed on Feb. 16, 2011.
(60) Provisional application No. 61/453,061, filed on Mar. 15, 2011.
(60) Provisional application No. 61/477,097, filed on Apr. 19, 2011.

(51) Int. Cl. F01K 25/00; C04B 14/26; B01D 53/62

(52) U.S. Cl. 60/643; 423/220; 106/817

(57) ABSTRACT

Provided herein are methods and systems for sequestering carbon dioxide from a multi-component gaseous stream, such as flue gas from natural gas-burning power plant to produce a protonated carbonate. Also provided herein are methods and systems for electrochemically producing proton-removing agents to form a deprotonated carbonate from the protonated carbonate. The electrochemical process may consume less energy than the amount of energy generated during production of the multi-component gaseous stream.

### CROSS-REFERENCE

This application is a Continuation-In-Part of pending U.S. application Ser. No. 12/698,741, filed Feb. 2, 2010 which claims priority to U.S. Pat. No. 7,887,694, issued Feb. 15, 2011. This application also claims priority to U.S. Provisional Application No. 61/360,397, filed Jun. 30, 2010; U.S. Provisional Application No. 61/479,153, filed Apr. 26, 2011; U.S. Provisional Application No. 61/441,194, filed Feb. 9, 2011; U.S. Provisional Application No. 61/443,607, filed Feb. 16, 2011; U.S. Provisional Application No. 61/453,061, filed Mar. 15, 2011; and U.S. Provisional Application No. 61/477,097, filed Apr. 19, 2011; which are all incorporated herein by reference in their entirety in the present disclosure.

### BACKGROUND

A major environmental problem may be global-warming. Carbon dioxide (CO₂) emissions have been identified as a contributor to the phenomenon of global warming and ocean acidification. CO₂ may be a by-product of combustion and may create operational, economic, and environmental problems. It may be expected that elevated atmospheric concentrations of CO₂ and other greenhouse gases may facilitate greater storage of heat within the atmosphere leading to enhanced surface temperatures and rapid climate change. CO₂ may also have been interacting with the oceans driving down the pH toward 8.0. CO₂ monitoring has shown that atmospheric CO₂ may have risen from approximately 280 parts per million (ppm) in the 1950s to approximately 380 ppm today, and is expected to exceed 400 ppm in the next decade. The impact of climate change may likely be economically expensive and environmentally hazardous. Reducing potential risks of climate change may require removal of CO₂ from sources which release CO₂ into the environment.

### SUMMARY

Aspects of the invention include methods of separating carbon dioxide from a multi-component gaseous stream. In some embodiments, the multi-component gaseous stream is flue gas from natural-gas burning power plant. In practicing methods according to certain embodiments, a multi-component gaseous stream containing carbon dioxide is contacted with an aqueous composition to produce protonated carbonate. Also provided are methods for electrochemically removing protons from the protonated carbonate to produce a deprotonated carbonate in a process that consumes less energy than the amount of energy generated during production of the multi-component gaseous stream. Aspects of the invention further include systems for practicing methods of the invention.

In some embodiments, the invention provides a method for separating carbon dioxide gas from a multi-component gaseous stream, comprising contacting a multi-component gaseous stream with an aqueous composition to produce a protonated carbonate. In one aspect, there is provided a method, comprising contacting a flue gas from a natural gas-burning power plant with an aqueous composition comprising a proton-removing agent under conditions to produce a deprotonated carbonate wherein the natural gas-burning power plant generates 1 ton or less of carbon dioxide per megawatt hour; and producing a carbonate-containing precipitation material from the deprotonated carbonate. In some embodiments, the natural gas-burning power plant generates 0.1-1 ton of carbon dioxide per megawatt hour. In some embodiments, the natural gas comprises methane, ethane, butane, propane, or combination thereof. In some embodiments, the methods provided herein further include electrochemically producing the proton-removing agent wherein the electrochemical process consumes less energy than an amount of energy generated during production of the flue gas from the natural gas-burning power plant. In some embodiments, the methods provided herein, the electrochemical process runs at a voltage of 1.2 V or less.

In some embodiments of the invention, protons from the protonated carbonate are electrochemically removed to produce a deprotonated carbonate, in a process that consumes less energy than the amount of energy generated during production of the multi-component gaseous stream. In some instances, the protonated carbonate comprises carbonic acid and bicarbonate. In some instances, the deprotonated carbonate comprises bicarbonate and carbonate. Where the source of the multi-component gaseous stream is a power plant, in some instances the multi-component gaseous stream is flue gas from a power plant. In some embodiments, the power plant is a natural gas-burning power plant. In some embodiments, the multi-component gaseous stream is produced by a source that generates 0.5 tons of carbon dioxide or less per megawatt hour.

In some embodiments, the methods provided herein, the electrochemical process comprises contacting an anode with a first electrolyte, contacting a cathode with a second electrolyte, and disposing an ion exchange membrane between the anode and the cathode. Aspects of the invention also include electrochemically removing protons from the protonated carbonate. In some embodiments, electrochemically removing protons comprises employing an electrochemical protocol that comprises applying a voltage across an anode and a cathode, where the anode is in contact with a first electrolyte and the cathode is in contact with a second electrolyte. In certain embodiments, the electrochemical protocol comprises migrating ions across an ion exchange membrane disposed between the first electrolyte and the second electrolyte. In some instances, the ion exchange membrane is a anion exchange membrane or a cation exchange membrane. Where desired, the electrochemical protocol comprises electrochemically producing hydroxide without forming oxygen or chlorine gas at the anode. In some embodiments, the electrochemical protocol comprises producing hydrogen gas at the cathode. In some embodiments, the electrochemical process in the methods provided herein, include producing hydroxide ions in the second electrolyte or the cathode electrolyte without forming an oxygen or chlorine gas at the anode. In some embodiments, the electrochemical process in the methods provided herein, include using hydrogen gas at the anode to form hydrogen ions. Electrochemical protocols or processes, according to some embodiments, comprise applying a voltage of 1.2 V or less, such as 0.6 V or less.

In some embodiments of the methods provided herein, the carbonate-containing precipitation material includes, but not limited to, NaHCO₃, Na₂CO₃, Ca(HCO₃)₂, Mg(HCO₃)₂, CaCO₃, MgCO₃, Na₃(HCO₃)(CO₃), or any combination thereof.

In some embodiments, the methods provided herein further include processing the carbonate-containing precipitation material to produce a building material selected from the group consisting of hydraulic cement, a supplementary cementitious material, aggregate, and combination thereof.

In some embodiments, the methods provided herein consume 70% or less energy than the amount of energy generated during production of the flue gas from the natural gas-burning power plant. In some embodiments, separating carbon dioxide from the multi-component gaseous stream, such as flue gas from natural-gas burning power plant, consumes 60% or less of the amount of the energy generated during production of the multi-component gaseous stream, such as for example 30% or less. In other embodiments, separating carbon dioxide from the multi-component gaseous stream comprises removing 50% or more of the carbon dioxide from the multi-component gaseous stream, such as for example 75% or more of the carbon dioxide from the multi-component gaseous stream.

Aspects of the invention may also include determining energy consumption of separating carbon dioxide from the multi-component gaseous stream and assessing the determined energy consumption of separating carbon dioxide from the multi-component gaseous stream to identify any desired adjustments to the energy consumption. In some embodiments, methods of the invention further include adjusting the energy consumption of separating carbon dioxide from the multi-component gaseous stream based on the determined energy consumption. In some embodiments, the methods provided herein further include determining energy consumption of the method; assessing the determined energy consumption to identify any desired adjustments to the energy consumption; and adjusting the energy consumption of the method based on the assessed energy consumption. In some embodiments, adjusting the energy consumption comprises electrochemically producing proton-removing agent during low energy cost periods or employing a renewable energy protocol. In some instances adjusting the energy consumption comprises electrochemically removing protons during low energy cost periods. In other instances, adjusting the energy consumption comprises employing a renewable energy protocol, where in some embodiments, renewable energy protocol may be solar energy, wind energy, compressed air or any combination thereof.

In one aspect, there is provided a method that includes contacting a flue gas from a natural gas-burning power plant with an aqueous composition comprising a proton-removing agent produced by an electrochemical process, wherein the electrochemical process comprises contacting an anode with a hydrogen gas produced from natural gas. In some embodiments, the method further comprises producing a deprotonated carbonate from the contacting the flue gas from the natural gas-burning power plant with the aqueous composition comprising the proton-removing agent produced by the electrochemical process and producing a carbonate-containing precipitation material from the deprotonated carbonate.

In some embodiments, the method further comprises at least one of producing a carbonate-containing precipitation material from the deprotonated carbonate and sequestering the deprotonated carbonate. In some instances, the method comprises producing a carbonate-containing precipitation material from a first amount of the deprotonated carbonate and sequestering a second amount of the deprotonated carbonate. Where desired, the ratio of the first amount of the deprotonated carbonate employed to produce the carbonate-containing precipitation material and the second amount of the deprotonated carbonate that is sequestered is between 100/1 and 1/100. In some embodiments, producing a carbonate-containing precipitation material comprises subjecting the carbonate-containing composition to precipitation conditions to produce a carbonate-containing precipitation material and depleted aqueous composition. In certain instances, the method further comprises separating the carbonate-containing precipitation material from the depleted aqueous composition. In some embodiments, the carbonate-containing precipitation material comprises NaHCO₃, Na₂CO₃, CaCO₃, MgCO₃, Na₃(HCO₃)(CO₃) or any combination thereof. In some instances, the carbonate-containing precipitation material comprises aragonite, vaterite, amorphous calcium carbonate, trona, or any combination thereof. In other embodiments, the method further comprises desalinating the depleted aqueous composition to produce a desalinated water. In yet other embodiments, the method further comprises processing the carbonate-containing precipitation material to produce a building material. Where processing the carbonate-containing precipitation material comprises producing a building material, the building material may be a hydraulic cement, a supplementary cementitious material or aggregate, or a combination thereof.

Aspects of the invention also include sequestering the deprotonated carbonate. Where some or all of the deprotonated carbonate is sequestered, sequestering the deprotonated carbonate comprises introducing the deprotonated carbonate into a sequestration location and maintaining the deprotonated carbonate in the sequestration location. In some embodiments, the sequestration location is a subterranean formation, where the subterranean formation may be located 100 meters or more below ground level.

In some embodiments, the invention provides a system for separating carbon dioxide from a multi-component gaseous stream comprising a source of a multi-component gaseous stream, a source of one or more aqueous compositions, one or more reactors configured for contacting the source of the multi-component gaseous stream and the source of one or more aqueous compositions to produce a protonated carbonate and an electrochemical system configured for removing protons from the protonated carbonate to produce a deprotonated carbonate, where the electrochemical system is configured to consume an amount of energy to remove protons from the protonated carbonate that is less than the amount of energy generated during the production of the multi-component gaseous stream. In some embodiments, the source of a carbon dioxide-containing multi-component gaseous stream is a gaseous waste stream. In some instances, the source of the gaseous waste stream is a conduit coupled to a natural gas-burning power plant.

In one aspect, there are provided system comprising a natural gas-burning source configured to produce power and flue gas wherein the natural gas-burning source generates the flue gas comprising 1 ton or less of carbon dioxide per megawatt hour; a source of one or more aqueous compositions; and one or more reactors operably connected to the sources and configured for contacting the flue gas and the one or more aqueous compositions to produce a protonated carbonate. In some embodiments, the systems provided herein further include a source of proton-removing agent operably connected to the source of one or more aqueous compositions or the one or more reactors and configured to deprotonate the protonated carbonate to form deprotonated carbonate. In some embodiments of the systems provided herein, the source of the proton-removing agent is an electrochemical system comprising an anode in contact with an anode electrolyte and a cathode in contact with a cathode electrolyte wherein the electrochemical system is configured to form the proton-removing agent in the cathode electrolyte.

In some embodiments, the systems provided herein further include a hydrogen gas delivery system operably connected to the anode electrolyte configured to deliver hydrogen gas from the natural-gas burning source to the anode wherein the anode is configured to form hydrogen ions from the hydrogen gas. In such embodiments, the natural-gas burning source that provides hydrogen gas to the anode of the electrochemical process may be the same source that also provides flue gas or may be a different source that only provides hydrogen gas. In some embodiments, the source of flue gas and the source of the hydrogen gas are the same, different, or combination of the two.

In some embodiments, the systems provided herein further include a contactor operably connected to the cathode electrolyte and configured to contact the flue gas with the cathode electrolyte. In such embodiments, the contactor may be a gas/liquid contactor, as described herein. In some embodiments, the gas/liquid contactor comprises a carbonate, such as, but not limited to, sodium carbonate which in contact with flue gas forms bicarbonate. In some embodiments, the bicarbonate is circulated to the cathode chamber containing the cathode electrolyte in the electrochemical process where the bicarbonate is converted to carbonate by the alkali present in the cathode electrolyte.

In some embodiments, the systems provided herein further include a carbonate-compound production station configured to produce a carbonate-containing precipitation material from the deprotonated carbonate, such as bicarbonate, carbonate, or combination thereof.

In some embodiments, the electrochemical system comprises an anode in contact with a first electrolyte and a cathode in contact with a second electrolyte. In these embodiments, the electrochemical system is configured to apply a voltage across the anode and cathode to produce hydroxide ions in the second electrolyte without forming oxygen or chlorine at the anode. In some instances, the first electrolyte and second electrolyte comprise seawater, freshwater, brine or brackish water. In other instances, the second electrolyte comprises sodium chloride. In yet other embodiments, the electrochemical system comprises an ion-exchange membrane disposed between the first electrolyte and the second electrolyte. Where the electrochemical system comprises an ion exchange membrane, the ion exchange membrane an anion exchange membrane or a cation exchange membrane. In some embodiments, the electrochemical system applies a voltage of 1.2 V or less. In other embodiments, the electrochemical system applies a voltage of 0.6 V or less. In some instances, the system is configured to consume 30% or less of the amount of energy generated to produce the multi-component gaseous stream.

In some embodiments, the system further comprises a detector configured to determine energy consumption of the system. In certain instances, the system further comprises a system operation module configured to control the system. In other instances, the system operation module further comprises an energy control station configured to adjust the energy consumption of the system. In some embodiments, the energy control station comprises an energy regulator configured to adjust the voltage employed by the electrochemical system. In certain embodiments, the system further comprises a renewable energy system. For example, the renewable energy system may be a solar panel system, a wind energy system, a compressed air system or a combination thereof.

Aspects of systems of the invention also include a system that is configured to perform at least one of sequestering the deprotonated carbonate and producing a carbonate-containing precipitation material from the deprotonated carbonate. In these embodiments, the system may further comprise a mass control station configured to regulate the amount of the deprotonated carbonate that is sequestered and the amount of the deprotonated carbonate that is employed to produce a carbonate-containing precipitation material. Where the system is configured to sequester a portion or all of the deprotonated carbonate, the system may further comprise one or more conduits for conveying the deprotonated carbonate to a sequestration location. In some instances, the sequestration location may be a subterranean formation. In other embodiments, the system further comprises a carbonate-compound production station configured to produce a carbonate-containing precipitation material and depleted aqueous composition. In these embodiments, the carbonate-compound production station may comprise a liquid-solid separator. In some instances, the carbonate-compound production station comprises a desalination station configured to produce desalinated water from the liquid product of the liquid-solid separator. In other instances, the carbonate-compound production station comprises a precipitate processing unit configured to produce a building material from the solid product of the liquid-solid separator.

### BRIEF DESCRIPTION OF DRAWINGS

The novel features of the invention are set forth with particularity in the appended claims. A better understanding of the features and advantages of the invention will be obtained by reference to the following detailed description that sets forth illustrative embodiments, in which the principles of the invention are utilized, and the accompanying drawings of which:

FIG. 1 illustrates an embodiment of the invention.

FIG. 2 illustrates an embodiment of the invention.

FIG. 2A illustrates an embodiment of the invention.

FIG. 3 illustrates an embodiment of the invention.

FIG. 3A illustrates an embodiment of the invention.

FIG. 4 illustrates a method embodiment for separating carbon dioxide from a multi-component gaseous stream, such as flue gas from natural-gas burning power plant.

FIG. 5 illustrates a system embodiment for separating carbon dioxide from a multi-component gaseous stream, such as flue gas from natural-gas burning power plant.

### DETAILED DESCRIPTION

Provided herein are methods and systems for separating carbon dioxide from a multi-component gaseous stream, such as, but not limited to, flue gas from natural-gas burning power plant. In methods and systems according to some embodiments, a multi-component gaseous stream containing carbon dioxide is contacted with an aqueous composition to produce a protonated carbonate. Also provided herein are methods and systems for electrochemically producing a proton-removing agent and removing protons from the protonated carbonate to produce a deprotonated carbonate. In some embodiments, the separation of carbon dioxide from a multi-component gaseous stream and/or the electrochemical process consumes less energy than the amount of energy generated during production of the multi-component gaseous stream. Further provided herein are systems for practicing methods of the invention.

Before the invention is described in greater detail, it is to be understood that the invention is not limited to particular embodiments described herein as such embodiments may vary. It is also to be understood that the terminology used herein is for the purpose of describing particular embodiments only, and the terminology is not intended to be limiting. The scope of the invention will be limited only by the appended claims. Unless defined otherwise, all technical and scientific terms used herein have the same meaning as commonly understood by one of ordinary skill in the art to which this invention belongs.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges may be presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number.

All publications, patents, and patent applications cited in this specification are incorporated herein by reference to the same extent as if each individual publication, patent, or patent application were specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided might be different from the actual publication dates, which may need to be independently confirmed.

It is noted that, as used herein and in the appended claims, the singular forms “a,” “an,” and “the” include plural references unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method may be carried out in the order of events recited or in any other order that is logically possible. Although any methods and materials similar or equivalent to those described herein may also be used in the practice or testing of the invention, representative illustrative methods and materials are now described.

In further describing the subject invention, the methods of separating carbon dioxide from a multi-component gaseous stream are described first in greater detail. Next, systems that find use in practicing various embodiments of the methods of the invention are described.

### A. Methods

In one aspect, there are provided methods that include separating carbon dioxide from a multi-component gaseous stream by contacting the multi-component gaseous stream with an aqueous composition to produce a protonated carbonate. The protonated carbonate may be converted to the deprotonated carbonate using a proton-removing agent. In some embodiments, the multi-component gaseous stream is a flue gas from a natural gas-burning power plant. Accordingly, there are provided methods that include contacting a flue gas from a natural gas-burning power plant with an aqueous composition comprising a proton-removing agent under conditions to produce a deprotonated carbonate. In some embodiments, the natural gas-burning power plant generates 1 ton or less of carbon dioxide per megawatt hour. The deprotonated carbonate may be used to form a carbonate-containing precipitation material. Such methods may be used for separating carbon dioxide from a multi-component gaseous stream, such as, but not limited to flue gas from natural-gas burning power plant.

The “separating carbon dioxide” from a multi-component gaseous stream, such as, but not limited to flue gas from natural-gas burning power plant, includes that the multi-component gaseous stream is modified or altered such that some or all of the carbon dioxide is no longer present in the multi-component gaseous stream. As such, the concentration of carbon dioxide in the multi-component gaseous stream or the flue gas may be decreased by methods of the invention by 10% or more, or such as 20% or more, or such as 30% or more, or such as 40% or more, or such as 50% or more, or such as 60% or more, or such as 70% or more, or such as 80% or more, or such as 90% or more, or such as 95% or more, or such as 99% or more, or such as between 10-99%, or such as between 10-90%, or such as between 10-80%, or such as between 10-50%. Such decreases in carbon dioxide concentration in the multi-component gaseous stream may be accomplished with yields described herein, or with lower yields, and may be accomplished by practicing methods of the invention one or more times. In some embodiments, separating carbon dioxide from a multi-component gaseous stream according to methods of the invention produces carbon dioxide in storage stable form.

The “storage stable” form includes carbon dioxide removed from the multi-component gaseous stream, such as flue gas from the natural-gas burning power plant, to produce a carbon dioxide product from an amount of carbon dioxide, such that the carbon dioxide from which the product is produced is then sequestered in that product. As such, the carbon dioxide product is a stable composition that incorporates an amount of carbon dioxide which can be stored for a period of time so that carbon dioxide is no longer present or available to the multi-component gaseous stream. The “storage stable” includes a form that can be stored, for example above ground or underwater, under exposed conditions (for example, open to the atmosphere, underwater environment, etc.), without significant, if any, degradation for extended durations, e.g., 1 year or longer, 5 years or longer, 10 years or longer, 25 years or longer, 50 years or longer, 100 years or longer, 250 years or longer, 1000 years or longer, 10,000 years or longer, 1,000,000 years or longer, or 100,000,000 years or longer, or 1,000,000,000 years or longer. As the storage stable form undergoes little if any degradation, the amount of degradation if any as measured in terms of CO₂ gas release from the product will not exceed 5%/year, and in certain embodiments will not exceed 1%/year or 0.001% per year.

### Multi-Component Gaseous Stream

In methods provided herein, a multi-component gaseous stream, such as, but not limited to, flue gas from natural-gas burning power plant is contacted with an aqueous composition to produce a protonated carbonate composition. A “multi-component gaseous stream” as used herein may be any gaseous composition containing one or more gaseous component. An example of the multi-component gaseous stream is flue gas from natural-gas burning power plant. As the multi-component gaseous stream will differ depending on the source, the amount of carbon dioxide in the multi-component gaseous stream may vary. Multi-component gaseous streams of the invention may contain carbon dioxide as the primary component, or may, in some instances, contain additional components such as water, nitrogen oxides (NOx; mononitrogen oxides, NO and NO₂), sulfur oxides (SOx; monosulfur oxides, SO, SO₂ and SO₃), VOC (Volatile organic compounds), mercury and particulates (particulate matter, particles of solid or liquid suspended in a gas), among other components. Additional gases and other components may include CO, mercury and other heavy metals, and dust particles. Additional components in the gas stream may also include halides such as hydrogen chloride and hydrogen fluoride; particulate matter such as fly ash, dusts, and metals including arsenic, beryllium, boron, cadmium, chromium, chromium VI, cobalt, lead, manganese, mercury, molybdenum, selenium, strontium, thallium, and vanadium; and organics such as hydrocarbons, dioxins, and PAH compounds. The combustion of natural gas releases carbon dioxide, water vapor and/or hydrogen and may release small amounts of sulfur dioxide and nitrogen oxides, virtually no or low amount of ash or particulate matter, and other reactive hydrocarbons.

Multi-component gaseous waste streams may, in certain embodiments, contain CO₂ present in amounts ranging from 200 ppm to 1,000,000 ppm, such as 200,000 ppm to 1000 ppm and including 200,000 ppm to 2000 ppm, for example 130,000 ppm to 2000 ppm. As such, the multi-component gaseous stream may be 10% CO₂ or more, such as 20% CO₂ or more, such as 30% CO₂ or more, such as 40% less CO₂ or more, such as 50% CO₂ or more, such as 60% CO₂ or more, such as 70% CO₂ or more, such as 80% CO₂ or more, such as 90% CO₂ or more, such as 95% CO₂ or more, such as 99% CO₂ or more including 99.5% CO₂ or more, such as 10-99%, such as 10-90%, such as 10-80%, or such as 10-50% CO₂. The temperature of the multi-component gaseous stream when it is contacted with the aqueous composition may also vary depending on the particular composition of the multi-component gaseous stream. In some instances, the temperature of the multi-component gaseous stream may range from 0° C. to 2000° C., such as from 25° C. to 750° C., such as from 50° C. to 500° C., including 100° C. to 250° C.

The multi-component gaseous stream that is employed in embodiments of the invention may be from any source known to one skilled in the art. The source of the multi-component gaseous stream is, in certain embodiments, a waste feed from a power plant. By waste feed is meant a stream of gas (or analogous stream) that is produced as a byproduct of an active process of the power plant. The gaseous stream may be substantially pure CO₂ or a multi-component gaseous stream that includes CO₂ and one or more additional gases. The nature of the power plant may vary in these embodiments, where power plants can include any industrial plant for generating power that produces a multi-component gaseous stream containing carbon dioxide as a byproduct of fuel combustion. In some embodiments, the source of the multi-component gaseous stream is a power plant that combusts coal, oil, crude petroleum, petroleum coke among other sources of fuel. In other embodiments, the source of the multi-component gaseous stream is a power plant that combusts fuels derived from tar sands, such as for example, oil shale, coal liquids, coal gasification and biofuels that are made available via syngas.

In certain embodiments, the source of the multi-component gaseous stream is power plant that combusts or burns natural gas. The “natural gas” is referred to herein in its conventional sense to include a mixture of combustible gases containing at least one hydrocarbon gas. In embodiments of the invention, natural gas may contain methane, ethane, propane, and butane, among other hydrocarbon gases. In addition, natural gases of the invention may also contain oxygen, nitrogen, hydrogen sulfide as well as trace elemental gases such as helium, neon and xenon. As different hydrocarbon gases may be present in varying amounts in natural gases of the invention, the amount of energy and carbon dioxide produced by the natural gas burning power plant may vary. In some embodiments, the multi-component gaseous stream, such as flue gas, is produced by a fuel, such as a natural-gas power plant, that generates 2.0 ton of carbon dioxide or less per megawatt hour of energy, such as 1.0 ton of carbon dioxide or less, such as 0.9 tons or less, such as 0.8 tons or less, such as 0.7 tons or less, such as 0.6 tons or less, such as 0.5 tons or less, such as 0.4 tons or less, such as 0.3 tons or less, such as 0.2 tons or less, such as 0.1 tons or less, or between 0.1-2 tons or less, or between 0.1-1.5 tons or less, or between 0.1-1 ton or less, or between 0.2-1 tons or less, or between 0.3-1 tons or less, or between 0.4-1 tons or less, or between 0.5-1 tons or less, or between 0.6-1 tons or less, or between 0.7-1 tons or less, or between 0.8-1 tons or less, or between 0.9-1 tons or less, or between 0.1-0.5 ton or less, or between 0.2-0.5 tons or less, or between 0.3-0.5 tons or less, or between 0.4-0.5 tons or less, or between 0.1-0.8 tons or less, or between 0.2-0.8 tons or less, or between 0.5-0.8 tons or less, or between 0.2-0.4 tons or less, or between 0.2-2 tons or less, per megawatt hour of energy. In certain embodiments, the multi-component gaseous stream is produced by a natural gas that generates 0.5 tons of carbon dioxide or less per megawatt hour of energy, such as 0.4 tons or less, such as 0.3 tons or less, such as 0.2 tons or less, including 0.1 tons or less.

The natural gas may be created typically by two mechanisms: biogenic and thermogenic. Biogenic gas may be created by methanogenic organisms in marshes, bogs, landfills, and shallow sediments. Deeper in the earth, at greater temperature and pressure, thermogenic gas may be created from buried organic material. Before natural gas can be used in the methods and systems provided herein, it may or may not be processed to remove materials other than methane. The other materials in the natural gas include, but not limited to, ethane, propane, butanes, pentanes, and higher molecular weight hydrocarbons, elemental sulfur, carbon dioxide, water vapor, and sometimes helium and nitrogen. The natural gas may be found in and/or extracted from oil fields, natural gas fields, coal beds, sour gas, tight gas, shale gas, town gas, or combination thereof. The natural gas may also be produced by anaerobic decay of non-fossil organic matter, such as, but not limited to, swamps, marshes, landfill, sewage sludge and manure. The natural gas may also be produced from hydrates found under sediment on offshore continental shelves and on land in arctic regions that experience permafrost such as those in Siberia (hydrates may require a combination of high pressure and low temperature to form).

The natural-gas burning process may include, but not limited to, combustion of methane and steam reformation. In the combustion of methane, several steps may be involved. In some embodiments, methane forms carbon monoxide (CO) and hydrogen gas, also called syngas. The process is called oxidative pyrolysis:

CH₄+O₂→CO+H₂+H₂O

Following oxidative pyrolysis, the H₂ may oxidize to form H₂O and release heat.

2H₂+O₂→2H₂O

Finally, the CO may oxidize, forming CO₂ and releasing more heat.

2CO+O₂→2CO₂

The result of the above is the following total equation:

CH₄(g)+2O₂(g)→CO₂(g)+2H₂O(l)

In some embodiments, steam reforming of natural gas or syngas may be referred to as steam methane reforming (SMR). In some embodiments of this method, at high temperatures (700-1100° C.) and in the presence of a metal-based catalyst (such as nickel), steam may react with methane to yield carbon monoxide and hydrogen. These two reactions may be reversible in nature.

CH₄+H₂O→CO+3H₂

Additional hydrogen may be recovered by a lower-temperature gas-shift reaction with the carbon monoxide produced. The reaction may be summarized by:

CO+H₂O→CO₂+H₂

### Aqueous Composition

The methods provided herein include contacting a multi-component gaseous stream, such as flue gas from natural-gas burning power plant, with an aqueous composition to produce a protonated carbonate. A portion of the multi-component gaseous stream (i.e., not the entire gaseous waste stream) from the source, such as a natural gas-burning power plant, may be contacted with the aqueous composition. In these embodiments, the portion of the multi-component gaseous stream that is contacted with the aqueous composition may be 75% or less, such as 60% or less, and including 50% and less of the gaseous waste stream. In other embodiments, substantially (e.g., 80% or more) the entire multi-component gaseous stream produced by the power plant may be contacted with the aqueous composition. In these embodiments, 80% or more, such as 90% or more, including 95% or more, up to 100% of the multi-component gaseous stream (e.g., flue gas) from the source is contacted with the aqueous composition.

Aspects of the invention include contacting an aqueous composition with a multi-component gaseous stream, such as flue gas from a natural gas-burning power plant. Depending on the particular method of separating carbon dioxide from the multi-component gaseous stream, the aqueous composition may vary. One type of water provided by methods of the invention is saltwater. The “saltwater” is employed in its conventional sense to refer to a number of different types of aqueous fluids other than fresh water, where the term “saltwater” includes brackish water, sea water and brine (including man-made brines, such as geothermal plant wastewaters, desalination waste waters, etc, as well as natural brines such as surface brines found in bodies of water on the surface of the earth and deep brines, found underneath the earth), as well as other salines having a salinity that is greater than that of freshwater. The “brine” includes water saturated or nearly saturated with salt and has a salinity that is 50 ppt (parts per thousand) or greater. Brackish water is water that is saltier than fresh water, but not as salty as seawater, having a salinity ranging from 0.5 to 35 ppt. Seawater is water from a sea or ocean and has a salinity ranging from 35 to 50 ppt. The saltwater source from may be a naturally occurring source, such as a sea, ocean, lake, swamp, estuary, lagoon, deep brine, alkaline lakes, inland seas, etc., or a man-made source.

Another type of aqueous composition that may be employed in methods of the invention is freshwater. Any suitable freshwater source may be used, including sources ranging from relatively free of minerals to sources rich in minerals. Freshwater sources of interest include mineral rich freshwater sources. Mineral rich freshwater sources of interest may be naturally occurring, such as hard waters or lakes or inland seas, for example alkaline lakes or inland seas (such as Lake Van in Turkey) which may provide a source of alkalinity for removal of protons and/or pH shift and/or a source of minerals. Mineral rich freshwater sources of interest may also be man-made, e.g., by producing a mineral rich water from a soft water. For example, a mineral poor (soft) water may be contacted with a source of desired ions, such as a calcium and/or magnesium ion source, to produce a mineral rich water that is suitable for use in the methods of the invention.

As indicated above, the aqueous composition employed in methods of the invention may be water that is obtained from naturally occurring sources. Alternatively, the water may be one that is prepared from an initial water, for example by adding one or more minerals to the water. As such, some methods include preparing the aqueous composition from the initial water by adding to the initial water a source of one or more divalent metal ions, such as alkaline earth metal ions including but not limited to, magnesium, calcium, etc. Sources of magnesium ions include, but are not limited to, magnesium hydroxides, magnesium oxides, etc. sources of calcium ions include, but are not limited to, calcium hydroxides, calcium oxides, etc. Both naturally occurring and man-made sources of such ions may be employed. Specific naturally occurring sources of such ions include, but are not limited to: mafic minerals, such as olivine, serpentine, periodotite, talc, etc., and the like. Addition of supplementary magnesium (Mg) ions to the source water, e.g., seawater, prior to precipitation may increase yields of precipitate as well as affect the composition of precipitate, providing a means for increasing CO₂ sequestration by utilizing minerals such as, but not limited to, olivine, serpentine and Mg(OH)₂ (brucite). The particular Mg ion source may be naturally occurring or man-made sources, and may be pure with respect to the Mg mineral or impure, e.g., be a composition made up of the Mg mineral of interest and other minerals and components.

In some embodiments, the aqueous composition may be an alkaline brine. The “alkaline brine” includes a concentrated aqueous composition which possesses sufficient alkalinity or basicity to remove one or more protons from proton-containing species in solution. As such, the stoichiometric sum of proton-removing agents in the alkaline brine exceeds the stoichiometric sum of proton-containing agents. The stoichiometric sum of proton-removing agents is the sum of all substances or compounds (e.g., halides, oxyanions, organic bases, etc.) which can remove one or more protons from proton-containing species in solution. In some instances, the alkaline brine has a pH that is above neutral pH (i.e., pH>7), e.g., the brine has a pH ranging from 7.1 to 12, such as 8 to 12, such as 8 to 11, and including 9 to 11. For example, the pH of the alkaline brine may be 9.5 or higher, such as 9.7 or higher, including 10 or higher. In some embodiments, the alkaline brine may be a subterranean brine. The term “subterranean brine” is employed in its conventional sense to refer to naturally occurring, saline composition. The saline composition may be obtained from a subterranean geological location, such as a deep geological alkaline aquifer or an underground well located in the sedimentary basins of a petroleum field, a subterranean metal ore, a geothermal field, or an oceanic ridge, among other underground locations. The subterranean location may be a location that 100 m or deeper below ground level, such as 200 m or deeper below ground level, such as 300 m or deeper below ground level, such as 400 m or deeper below ground level, such as 500 m or deeper below ground level, such as 600 m or deeper below ground level, such as 700 m or deeper below ground level, such as 800 m or deeper below ground level, such as 900 m or deeper below ground level, such as 1000 m or deeper below ground level, including 1500 m or deeper below ground level, 2000 m or deeper below ground level, 2500 m or deeper below ground level and 3000 m or deeper below ground level. Subterranean brines of the invention may include, but are not limited to, compositions typically known as oil-field brines, basinal brines, basinal water, pore water, formation water, and deep sea hypersaline waters, among others. Such subterranean brines, methods for obtaining and use are described in co-pending U.S. Application Ser. No. 61/264,564 filed on Nov. 25, 2009; the disclosure of which application is herein incorporated by reference in its entirety.

The dissolution of CO₂ from the multi-component gaseous stream, such as flue gas from a natural gas-burning power plant, into the aqueous composition produces a protonated carbonate composition. The “protonated carbonate” includes a carbonate-containing compound possessing one or more protons. For example, a protonated carbonate may be carbonic acid (H₂CO₃). In other instances, the protonated carbonate may be bicarbonate (HCO₃⁻). In some embodiments, protonated carbonate compositions of the invention may include a mixture of carbonic acid and bicarbonate. Where both carbonic acid and bicarbonate are present, the molar ratio of carbonic acid to bicarbonate (i.e., H₂CO₃: HCO₃⁻) in the protonated carbonate composition may vary, and in some instances may range between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the molar ratio of carbonic acid to bicarbonate in protonated carbonate compositions of the invention may range between 1:1 and 1:10; 1:5 and 1:25; 1:10 and 1:50; 1:25 and 1:100; 1:50 and 1:500; or 1:100 and 1:1000. In some embodiments, the ratio of bicarbonate to carbonic acid (i.e., HCO₃⁻: H₂CO₃) in the protonated carbonate composition ranges between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the ratio of HCO₃⁻ to H₂CO₃ in the protonated carbonate compositions of the invention may range between 1:1 and 1:10; 1:5 and 1:25; 1:10 and 1:50; 1:25 and 1:100; 1:50 and 1:500; or 1:100 and 1:1000.

In some embodiments, where the aqueous composition possesses little to no alkalinity or basicity (i.e., the aqueous composition has a pH close to 7, such as pH 6.5 to 8.0, such as 6.5 to 7.5, including 6.8 to 7.2), the protonated carbonate composition produced by contacting the multi-component gaseous stream with the aqueous composition is substantially all in the form of carbonic acid, such as where the molar ratio of carbonic acid to bicarbonate (H₂CO₃/HCO₃⁻) is 200/1 or greater, such as 500/1 or greater, such as 1000/1 or greater, such as 5000/1 or greater, including 10,000/1 or greater. In other embodiments, aqueous compositions of the invention possess an alkalinity or basicity (e.g., a pH ranging between 8 to 11, such as 8 to 10.5, including 9 to 10) that is sufficient to deprotonate carbonic acid to produce bicarbonate. As such, in these embodiments, after the multi-component gaseous stream is contacted with the aqueous composition, the protonated carbonate composition is substantially all in the form of bicarbonate, such as where the molar ratio of bicarbonate to carbonic acid (HCO₃⁻/H₂CO₃) is 200/1 or greater, such as 500/1 or greater, such as 1000/1 or greater, such as 5000/1 or greater, including 10,000/1 or greater. In some instances, an aqueous composition having an alkalinity or basicity (e.g., a pH ranging between 8 to 11, such as 8 to 10.5, including 9 to 10) that is sufficient to deprotonate carbonic acid to produce bicarbonate may be a high carbonate alkaline brine. The high carbonate alkaline brine includes an aqueous composition which possesses carbonate in a sufficient amount so as to remove one or more protons from the protonated carbonate composition such that carbonic acid is converted to bicarbonate. As such, the amount of carbonate present in high carbonate alkaline brines of the invention may be 5,000 ppm or greater, such as 10,000 ppm greater, such as 25,000 ppm or greater, such as 50,000 ppm or greater, such as 75,000 ppm or greater, including 100,000 ppm or greater. Therefore, an initial reaction which may be carried out when carbon dioxide from the multi-component gaseous stream is contacted with a high carbonate containing alkaline brine is the formation of a protonated carbonate composition comprising substantially all bicarbonate:

Na₂CO₃(s)+CO₂(g)+H₂O---->2NaHCO₃(aq)

In some instances, aqueous compositions of the invention possess sufficient alkalinity such that some or all of the CO₂ contacted with the aqueous composition is converted to bicarbonate without the need to add any additional proton-removing agents. Where the source of alkalinity in the aqueous composition is carbonate, sufficient alkalinity includes the aqueous composition of the invention containing an amount of carbonate such that 10% or greater of the protonated carbonate composition produced by contacting the multi-component gaseous stream with an aqueous composition is bicarbonate, such as 25% or greater, such as 50% or greater, such as 75% or greater, such as 90% or greater, such as 95% or greater, and including 99% or greater of the protonated carbonate composition is bicarbonate. Therefore, some embodiments the invention provide a method of separating carbon dioxide from a multi-component gaseous stream, such as flue gas from the natural-gas burning power plant, in the form of bicarbonate by contacting the multi-component gaseous stream with an aqueous composition possessing sufficient alkalinity to convert some or all of the carbon dioxide into bicarbonate. For example, the aqueous composition containing a carbonate may be contacted with the flue gas to form the bicarbonate. In some embodiments, the aqueous composition comprises up to 90%/w solid; or up to 80% w/w solid; or up to 70% w/w solid; or up to 60% w/w solid; or up to 50% w/w solid; or up to 40% w/w solid; or up to 30% w/w solid; or up to 20% w/w solid; or up to 10% w/w solid; or up to 5% w/w solid; or up to 1% w/w solid; or between 1-90% w/w solid; or between 1-80% w/w solid; or between 1-70% w/w solid; or between 1-60% w/w solid; or between 1-50% w/w solid; or between 1-40% w/w solid; or between 1-30% w/w solid; or between 1-20% w/w solid; or between 1-10% w/w solid; or between 1-5% w/w solid; or between 0.1-1% w/w solid. In some embodiments, the solid in aqueous composition is a carbonate such as, but not limited to, sodium carbonate or potassium carbonate.

The multi-component gaseous stream may be contacted with the aqueous composition by any convenient protocol. For example, contact protocols of interest include, but are not limited to: direct contacting protocols, e.g., bubbling the multi-component gaseous stream through the volume of the aqueous composition, concurrent contacting protocols, i.e., contact between unidirectionally flowing gaseous and liquid phase streams, countercurrent protocols, i.e., contact between oppositely flowing gaseous and liquid phase streams, and the like. Thus, contact may be accomplished through use of infusers, bubblers, fluidic Venturi reactors, spargers, gas filters, sprays, trays, or packed column reactors, and the like, as may be convenient. For system and methods for contacting the aqueous composition with the multi-component gaseous stream, see U.S. Provisional Patent Application Nos. 61/158,992, filed 10 Mar. 2009; 61/168,166, filed 9 Apr. 2009; 61/170,086, filed 16 Apr. 2009; 61/178,475, filed 14 May 2009; 61/228,210, filed 24 Jul. 2009; 61/230,042, filed 30 Jul. 2009; and 61/239,429, filed 2 Sep. 2009, each of which disclosures is incorporated herein by reference.

### Proton-Removing Agent

In some aspects and embodiments, the methods of the invention include removing protons from the protonated carbonate composition to produce a deprotonated carbonate composition. Such methods may include electrochemical methods. The “deprotonated carbonate” as used herein, includes a product after removing one or more protons from the protonated carbonate composition as described herein. As such, in some embodiments a deprotonated carbonate is bicarbonate (HCO₃⁻) and/or carbonate (CO₃²⁻).

In order to produce carbonate-containing precipitation material, protons may be removed from various species (e.g. carbonic acid, bicarbonate, hydronium, etc.) in the divalent cation-containing solution to shift the equilibrium towards deprotonated carbonate. The “source of alkalinity” or “proton removing agents” or “pH raising agent,” or “base,” are used interchangeably herein. The “proton-removing agent” as used herein includes any agent that removes protons from the protonated carbonate. As protons are removed, more CO₂ goes into solution. In some embodiments, proton-removing agents and/or methods are used while contacting a divalent cation-containing aqueous composition with CO₂ to increase CO₂ absorption in one phase of the precipitation reaction, wherein the pH may remain constant, increase, or even decrease, followed by a rapid removal of protons (e.g., by addition of a base) to cause rapid precipitation of carbonate-containing precipitation material. Protons may be removed from the various species (e.g. carbonic acid, bicarbonate, hydronium, etc.) by any suitable approach, including, but not limited to, use of naturally occurring proton-removing agents, such as, but not limited to, minerals such as mafic minerals, ultramafic minerals, lime (CaO), periclase (MgO), iron hydroxide minerals (e.g., goethite and limonite), and volcanic ash; naturally occurring alkaline bodies of water including, but not limited to surface water sources (e.g. alkaline lakes such as Mono Lake in California) and ground water sources (e.g. basic aquifers such as the deep geologic alkaline aquifers located at Searles Lake in California); use of microorganisms and fungi; use of synthetic chemical proton-removing agents including, but not limited to, hydroxides, organic bases, super bases, oxides, ammonia, and carbonates; recovery of man-made waste streams such as, but not limited to, mining wastes, fossil fuel burning ash (e.g., combustion ash such as fly ash, bottom ash, boiler slag), slag (e.g. iron slag, phosphorous slag), cement kiln waste, oil refinery/petrochemical refinery waste (e.g. oil field and methane seam brines), coal seam wastes (e.g. gas production brines and coal seam brine), paper processing waste, water softening waste brine (e.g., ion exchange effluent), silicon processing wastes, agricultural waste, metal finishing waste, high pH textile waste, and caustic sludge; and using electrochemical means to form alkali.

Depending on the proton removing agent employed, carbonate may be produced by removing one proton from bicarbonate or two protons from carbonic acid. In some embodiments, a deprotonated carbonate may be bicarbonate (HCO₃⁻), produced by electrochemically removing a single proton from carbonic acid. In some embodiments, deprotonated carbonate compositions of the invention may include a mixture of carbonate and bicarbonate. In deprotonated carbonate compositions where both carbonate and bicarbonate are present, the molar ratio of carbonate to bicarbonate (i.e., CO₃²⁻: HCO₃⁻) in the deprotonated carbonate composition may vary, and in some instances may range between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the molar ratio of carbonate to bicarbonate in deprotonated carbonate compositions of the invention may range between 1:1 and 1:10; 1:5 and 1:25; 1:10 and 1:50; 1:25 and 1:100; 1:50 and 1:500; or 1:100 and 1:1000. In some embodiments, the ratio of bicarbonate to carbonate (i.e., HCO₃⁻:CO₃²⁻) in the deprotonated carbonate composition ranges between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the ratio of HCO₃⁻ to CO₃²⁻ in the deprotonated carbonate compositions of the invention may range between 1:1 and 1:10; 1:5 and 1:25; 1:10 and 1:50; 1:25 and 1:100; 1:50 and 1:500; or 1:100 and 1:1000.

### Electrochemical Methods

Some examples of the electrochemical methods to produce proton-removing agent are described herein. It is to be understood that these electrochemical methods are for illustration purposes and that any electrochemical method that produces an alkali can be employed in the methods of the invention.

In one aspect, there are provided methods including contacting a flue gas from a natural gas-burning power plant with an aqueous composition comprising a proton-removing agent produced by an electrochemical process, wherein the electrochemical process comprises contacting an anode with a hydrogen gas produced from natural gas. In some embodiments, the methods provided herein further include producing a deprotonated carbonate from the contacting of the flue gas from the natural gas-burning power plant with the aqueous composition comprising the proton-removing agent produced by the electrochemical process and producing a carbonate-containing precipitation material from the deprotonated carbonate.

In some embodiments, protons from the protonated carbonate composition are electrochemically removed or are removed by alkali generated electrochemically to produce a deprotonated carbonate composition. In some embodiments, protons from the protonated carbonate composition may be removed by alkali generated by low-voltage electrochemical methods. By “low voltage” is meant that the employed electrochemical process operates at an average voltage of 2, 1.9, 1.8, 1.7, or 1.6 V or less, such as 1.5, 1.4, 1.3, 1.2, 1.1 V or less, such as 1 V or less, such as 0.9 V or less, 0.8 V or less, 0.7 V or less, 0.6 V or less, 0.5 V or less, 0.4 V or less, 0.3 V or less, 0.2 V or less, 0.1 V or less, between 0.1-2V, 0.1-1V, or 0.1-0.5V. In some embodiments, methods of the invention employ low-voltage electrochemical methods that do not generate chlorine gas. In other embodiments, low-voltage electrochemical methods that do not generate oxygen gas may be employed. In some embodiments low-voltage electrochemical methods that produce no gas at the anode may be employed. Methods of the invention may also include low-voltage electrochemical methods that generate hydrogen gas at the cathode and transport it to the anode where the hydrogen gas is converted to protons. In other embodiments, electrochemical methods that do not generate hydrogen gas may also be employed. In some embodiments, electrochemical methods use hydrogen gas at the anode that is produced from natural gas. In some embodiments, electrochemical methods that use an oxygen depolarized cathode and hydrogen oxidizing anode are employed. In some embodiments, electrochemical methods that use an oxygen depolarized cathode and hydrogen oxidizing anode where the hydrogen at the anode is from reformation of natural gas, are employed.

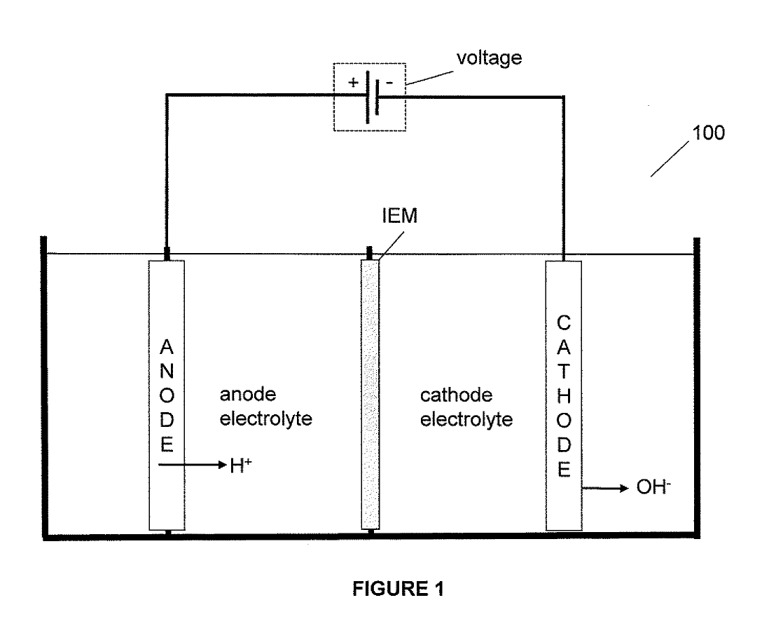

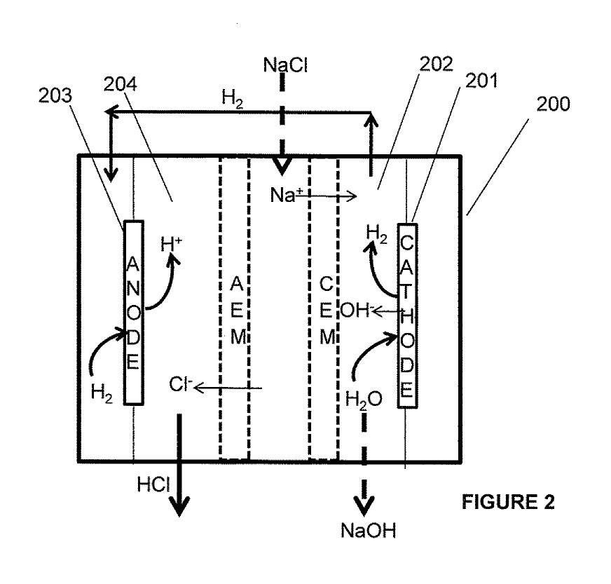

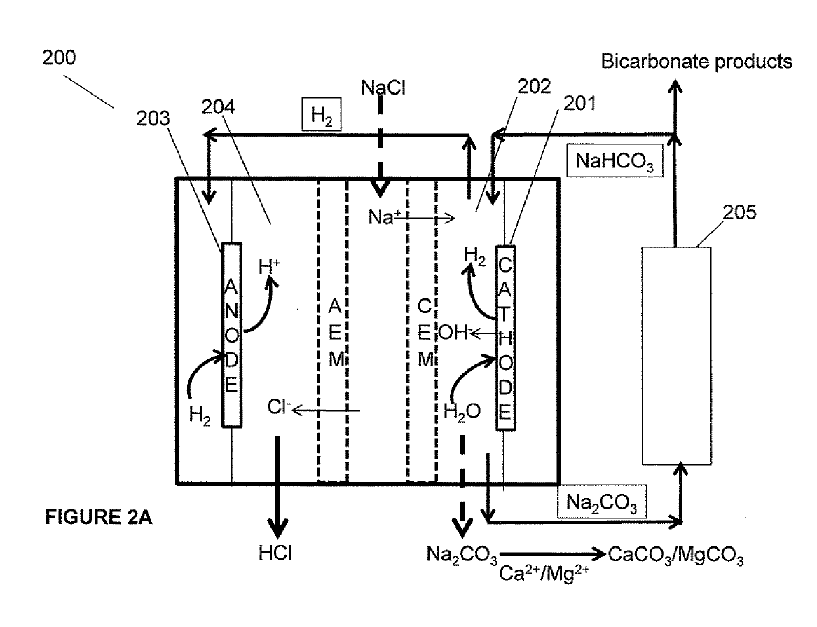

In some embodiments, as illustrated in FIG. 1, the electrochemical system 100 includes a cathode in contact with a cathode electrolyte and an anode in contact with an anode electrolyte. The anode and the cathode are separated by an ion exchange membrane (IEM). The cathode generates hydroxide ions and anode generates hydrochloric acid. The hydroxide formed in the cathode electrolyte is then withdrawn from the cathode chamber and used to form deprotonated carbonate from protonated carbonate. In some embodiments, as illustrated in FIG. 2, the electrochemical system 200 includes a cathode 201 in contact with a cathode electrolyte 202 and a gas-diffusion anode 203 in contact with an anode electrolyte 204. The anode and the cathode are separated by an anion exchange membrane (AEM) and a cation exchange membrane (CEM). A third electrolyte (e.g., sodium chloride) is disposed between the AEM and the CEM. The cathode 201 generates hydroxide ions and hydrogen gas which hydrogen gas is transferred to the anode 203 for oxidation to hydrogen ions. The sodium ions from the third electrolyte pass through CEM to form sodium hydroxide in the cathode chamber and the chloride ions from the third electrolyte pass through the AEM to form HCl in the anode chamber. The sodium ions pass through the CEM to the cathode 201 where hydroxide ions generated at the cathode combine with sodium ions to form sodium hydroxide. The NaOH formed in the cathode electrolyte 202 is then withdrawn from the cathode chamber and used to form deprotonated carbonate from protonated carbonate. Such electrochemical systems are described in US Patent Application Publication No. 2010/0230293, filed Jul. 15, 2009, which is incorporated herein by reference in its entirety.

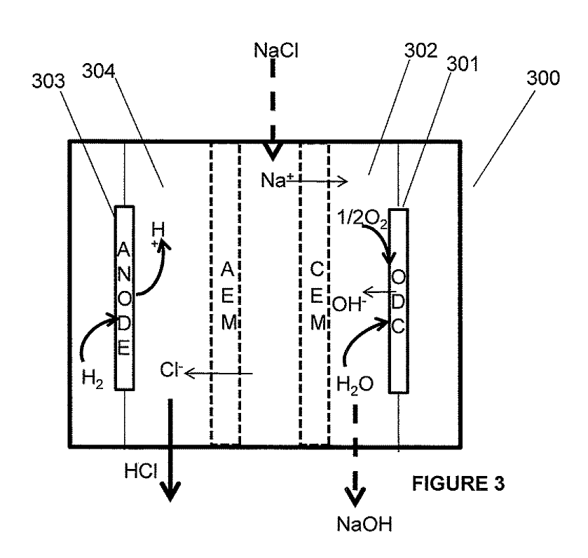

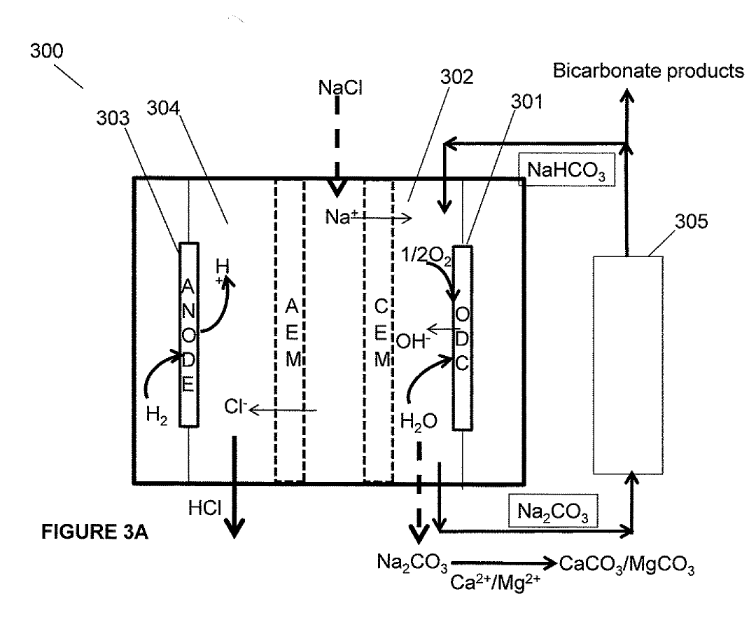

In some embodiments, as illustrated in FIG. 3, the combination of the gas diffusion cathode and the gas diffusion anode in the electrochemical cell results in the generation of acid in the anode chamber and generation of alkali in the cathode chamber. In some embodiments, the electrochemical system 300 includes a gas diffusion cathode 301 in contact with a cathode electrolyte 302 and a gas diffusion anode 303 in contact with an anode electrolyte 304. The anode and the cathode are separated by an anion exchange membrane (AEM) and a cation exchange membrane (CEM). A third electrolyte (e.g., sodium chloride) is disposed between the AEM and the CEM. In some embodiments, the gas diffusion cathode 301 is an oxygen depolarized cathode and the gas diffusion anode 303 is a hydrogen gas diffusion anode. The hydrogen is converted to hydrogen ions at the anode 303 and the oxygen is converted to hydroxide ions at the cathode 301 in the electrochemical reaction. In some embodiments, in the presence of an anode and/or cathode electrolyte, such as, but not limited to, sodium chloride, an acid such as, hydrochloric acid and an alkali, such as, sodium hydroxide are formed in the electrochemical cell. The NaOH formed in the cathode electrolyte 302 is then withdrawn from the cathode chamber and used to form deprotonated carbonate from protonated carbonate. Such electrochemical systems are described in U.S. Provisional Application No. 61/477,097, filed Apr. 19, 2011, which is incorporated herein by reference in its entirety.

In some embodiments of the electrochemical processes, as described herein, the hydrogen gas delivered at the anode may be the hydrogen gas formed at the cathode. In some embodiments, the hydrogen gas delivered at the anode may be the hydrogen gas formed by methane reformation process or natural-gas burning process, as described herein. In some embodiments, the hydrogen gas delivered at the anode may be the hydrogen gas obtained by the combination of one or more of hydrogen gas formed at the cathode, hydrogen gas formed by natural-gas burning process, or hydrogen gas formed by electrolysis processes, reformation processes, biological processes, or chemical processes. Examples of electrolysis process include, but not limited to, chloralkali process, water electrolysis, or combination thereof. Examples of reformation process include, but not limited to, steam reforming including, but not limited to, reformation of methane or natural gas, hydrocarbon fuel reformation, or combination thereof. Examples of chemical process include, but not limited to, partial oxidation of fuel-air mixture, plasma reforming, syngas treatment, catalytic reforming of naphtha, sulfur-iodine cycle, landfill gas treatment, or combination thereof. In some embodiments, the hydrogen gas supplied to the anode is obtained from a one or more processes including, but not limited to, chloralkali process; water electrolysis; steam reforming including, but not limited to, reformation of methane or natural gas and hydrocarbon fuel reformation; partial oxidation of fuel-air mixture; plasma reforming; syngas treatment; catalytic reforming of naphtha; sulfur-iodine cycle; biological process; landfill gas treatment; or combination thereof.

In some embodiments of the electrochemical process, not shown in the figures, the cathode electrolyte may be directly contacted with the multi-component gaseous stream, such as, flue gas from a natural-gas burning power plant or the cathode electrolyte may be contacted with the aqueous composition containing protonated carbonate composition obtained after contacting the aqueous composition with the multi-component gaseous stream, such as, flue gas from a natural-gas burning power plant. In some embodiments, the cathode electrolyte is circulated to the aqueous composition which is contacted with the multi-component gaseous stream, which cathode electrolyte containing the protonated carbonate composition is re-circulated back to the cathode electrolyte in the cathode chamber to form a loop. In some embodiments, the cathode electrolyte is withdrawn from the cathode chamber to form carbonate-containing precipitation material or for sequestration.

An example of an electrochemical process or system is illustrated in FIG. 2A and FIG. 3A, where the electrochemical system 200 of FIG. 2 or system 300 of FIG. 3, respectively includes a contactor 205 and 305, which is connected to the cathode chamber containing the cathode and the cathode electrolyte. The contactor is operably connected to a source of multi-component gaseous stream, such as, but not limited to, flue gas from natural-gas burning power plant (not shown in the figures). In some embodiments, the contactor is a gas/liquid contactor. The flue gas from the natural-gas burning power plant is passed into the contactor which may be a solid bed of an alkali such as but not limited to, carbonate and/or hydroxide or is an aqueous composition of carbonate and/or hydroxide. The carbonate present in the contactor reacts with the carbon dioxide present in the flue gas and forms a bicarbonate solution which is then circulated to the cathode electrolyte. In some embodiments, where the contactor contains a hydroxide only, the flue gas absorption in the contactor may result in bicarbonate, carbonate, or mixture thereof. The alkali, such as, but not limited to, hydroxide, formed in the cathode electrolyte deprotonates the bicarbonate from the contactor into the carbonate and forms a carbonate solution. In some embodiments, the carbonate solution may be then transferred back to the contactor for further absorption of the flue gas or the carbonate solution is withdrawn from the cathode chamber and is treated with divalent cations, such as alkaline earth metal ions to form carbonate containing precipitation material. In some embodiments, the bicarbonate solution may be withdrawn from the contactor to form bicarbonate products. It is to be understood that depending on the pH of the cathode electrolyte, the exiting sodium carbonate solution may contain some hydroxide or may substantially be sodium carbonate solution.

Electrochemical methods of the invention may in some instances, remove protons without the production of hydroxide (e.g., if proton production from carbon dioxide dissolution matches or exceeds proton removal by an electrochemical process). In other instances, electrochemical methods employed in removing protons from the protonated carbonate may produce hydroxide. In certain embodiments, hydroxide ions are formed where the voltage applied across the anode and cathode is 2.5 V or less without the formation of gas at the anode, such as 2.2 V or less, such as 2.0 V or less, such as 1.5 V or less, such as 1.2 V or less, such as 1.0 V or less, such as 0.8 V or less, such as 0.7 V or less, such as 0.6 V or less, such as 0.5 V or less, such as 0.4 V or less, such as 0.3 V or less, such as 0.2 V or less, such as 0.1 V or less, including 0.05 V or less.

In some instances, electrochemical methods may be employed to remove protons from the aqueous composition (e.g., deprotonation of hydronium or water) prior to contacting the multi-component gaseous stream with the aqueous composition. Deprotonation of the aqueous composition may result, for example, if proton production from CO₂ dissolution matches or exceeds electrochemical proton removal from solute molecules.

In certain embodiments, the present invention provides a low energy electrochemical system and method for removing protons from the protonated carbonate composition by employing an ion exchange membrane in an electrochemical cell. The system in some embodiments includes an anionic or cationic exchange membrane (e.g., in FIGS. 2 and 3) positioned between a first electrolyte and a second electrolyte, the first electrolyte (anode electrolyte) contacting an anode and the second electrolyte (cathode electrolyte) contacting a cathode. In some embodiments, electrolytes may be a saltwater such as sodium chloride, seawater, brackish water or freshwater, as described above. In some embodiments, on applying a low voltage across the anode and cathode, hydroxide forms at the cathode and protons form at the anode without a gas, e.g., chlorine or oxygen, forming at the anode. Depending on the electrolytes used, a hydroxide solution, e.g., sodium hydroxide, forms in the second electrolyte in contact with the cathode and an acid, e.g., hydrochloric acid forms in the first electrolyte in contact with the anode. In certain embodiments, electrochemical methods of the invention produce hydroxide in the second electrolyte when a voltage of 1.0 V or less is applied across the electrodes, such as 0.9 V or less, such as 0.8 V or less, such as 0.7 V or less, such as 0.6 V or less, such as 0.5 V or less, such as 0.4 V or less, such as 0.3 V or less, such as 0.2 V or less and including 0.1 V or less is applied across the electrodes.

In certain embodiments, protons are electrochemically removed from the protonated carbonate composition by employing an electrochemical system possessing an anion exchange membrane separating a first electrolyte from a second electrolyte; a cation exchange membrane separating the third electrolyte from a first electrolyte; an anode in contact with the first electrolyte (anode electrolyte); and a cathode in contact with a second electrolyte (cathode electrolyte). On applying a low voltage across the anode and cathode, hydroxide forms at the cathode without forming a gas, e.g., chlorine or oxygen forming at the anode. Depending on the electrolyte used, a hydroxide solution, e.g., sodium hydroxide, forms in the second electrolyte in contact with the cathode, and an acid, e.g., hydrochloric acid forms in the first electrolyte in contact with the anode. In certain embodiments, electrochemical methods of the invention produce hydroxide in the second electrolyte when a voltage of 1.0 V or less is applied across the electrodes, such as 0.9 V or less, such as 0.8 V or less, such as 0.7 V or less, such as 0.6 V or less, such as 0.5 V or less, such as 0.4 V or less, such as 0.3 V or less, such as 0.2 V or less and including 0.1 V or less is applied across the electrodes.

In certain embodiments, an electrochemical method for electrochemically removing protons from the protonated carbonate includes migrating ions across an ion exchange membrane (e.g., FIG. 1) in an electrochemical cell, wherein the ion exchange membrane is disposed between a first electrolyte and a second electrolyte, the first electrolyte contacting an anode and the second electrolyte contacting a cathode, by applying a voltage across the anode and cathode to form hydroxide ions at the cathode without forming a gas, e.g., chlorine or oxygen at the anode. Depending on the electrolyte used, a hydroxide solution, e.g., sodium hydroxide forms in the second electrolyte in contact with the cathode and an acid, e.g., hydrochloric acid forms in the first electrolyte in contact with the anode. In certain embodiments, electrochemical methods of the invention produce hydroxide in the second electrolyte when a voltage of 1.0 V or less is applied across the electrodes, such as 0.9 V or less, such as 0.8 V or less, such as 0.7 V or less, such as 0.6 V or less, such as 0.5 V or less, such as 0.4 V or less, such as 0.3 V or less, such as 0.2 V or less and including 0.1 V or less is applied across the electrodes.

In some embodiments, electrochemical methods for removing protons from the protonated carbonate includes applying a voltage across an anode and cathode, where the anode is in contact with a first electrolyte (anode electrolyte) and is in contact with an anion exchange membrane; the cathode is in contact with a second electrolyte (cathode electrolyte) and is in contact with a cation exchange membrane; and a third electrolyte disposed between the anion exchange membrane and the cation exchange membrane to form hydroxide ions at the cathode without forming a gas e.g., chlorine or oxygen at the anode. In embodiments of the invention, hydroxide is produced at the cathode in contact with the second electrolyte without a gas e.g., chlorine or oxygen at the anode. Depending on the electrolyte used, a hydroxide solution, e.g. sodium hydroxide, forms in the second electrolyte in contact with the cathode, and an acid, e.g., hydrochloric acid forms in the first electrolyte in contact with the anode. In certain embodiments, electrochemical methods of the invention produce hydroxide in the second electrolyte when a voltage of 1.0 V or less is applied across the electrodes, such as 0.9 V or less, such as 0.8 V or less, such as 0.7 V or less, such as 0.6 V or less, such as 0.5 V or less, such as 0.4 V or less, such as 0.3 V or less, such as 0.2 V or less and including 0.1 V or less is applied across the electrodes.

In various configurations, methods for electrochemically removing protons from the protonated carbonate may be adapted for batch, semi-batch or continuous flows. As such, in some instances, protons may be electrochemically removed from all or a portion of the protonated carbonate composition. For example, protons may be electrochemically removed from 10% or more of the protonated carbonate composition, such as 20% or more of the protonated carbonate composition, such as 25% or more of the protonated carbonate composition, such as 30% or more of the protonated carbonate composition, such as 40% or more of the protonated carbonate composition, 10% or more of the protonated carbonate composition, such as 50% or more of the protonated carbonate composition, such as 60% or more of the protonated carbonate composition, such as 70% or more of the protonated carbonate composition, such as 75% or more of the protonated carbonate composition, such as 80% or more of the protonated carbonate composition, such as 90% or more of the protonated carbonate composition, including 95% or more of the protonated carbonate composition. In certain instances, protons may be electrochemically removed from 100% of the protonated carbonate composition.

In some embodiments, a first and a second electrochemical method may be employed to remove protons from the protonated carbonate composition in a sequential fashion. For example, where the protonated carbonate is carbonic acid, a first electrochemical method may be employed, such as described above to remove a first proton from carbonic acid to produce bicarbonate. Further, a second electrochemical method may be employed to remove a second proton from bicarbonate to produce carbonate. The two processes may have different voltage requirements, e.g., the first process may require lower voltage than the second, thus minimizing total overall voltage used in the process. For example, the first process may operate at 1.0V or less, or 0.9V or less, or 0.8V or less, or 0.7V or less, or 0.6V or less, or 0.5V or less, or 0.4V or less, or 0.3V or less, or 0.2V or less, or 0.1V or less, while the second process may operate at 1.5 V or less, or 1.4V or less, or 1.3V or less, or 1.2V or less, or 1.1 V or less, 1.0V or less, or 0.9V or less, or 0.8V or less, or 0.7V or less, or 0.6V or less, or 0.5V or less, or 0.4V or less, or 0.3V or less, or 0.2V or less, or 0.1V or less, or between 0.1-1V. For example, in some embodiments the first process is a bielectrode process operating at 0.6 V or less and the second process is a low-voltage hydroxide producing process operating at 1.2V or less.

Electrochemical methods for removing protons from the protonated carbonate composition may include, but are not limited, those described in U.S. patent application Ser. No. 12/344,019, filed 24 Dec. 2008; U.S. patent application Ser. No. 12/375,632, filed 23 Dec. 2008, International Patent Application No. PCT/US08/088,242, filed 23 Dec. 2008; International Patent Application No. PCT/US09/32301, filed 28 Jan. 2009; International Patent Application No. PCT/US09/48511, filed 24 Jun. 2009; U.S. patent application Ser. No. 12/541,055 filed 13 Aug. 2009; and U.S. patent application Ser. No. 12/617,005, filed 12 Nov. 2009, the disclosures of which are incorporated herein by reference in their entirety. Also of interest are electrochemical methods described in published United States Application Publication Nos. 2006/0185985 and 2008/0248350, as well as published PCT Application Publication No. WO 2008/018928; the disclosures of all of which are herein incorporated by reference, in their entireties.

The electrochemical methods and systems provided herein include one or more of the following components.

In some embodiments, the gas-diffusion anode may contain a corrosion stable, electrically conductive base support. Such as, but not limited to, amorphous carbon, such as carbon black, fluorinated carbons like the specifically fluorinated carbons described in U.S. Pat. No. 4,908,198 and available under the trademark SFC™ carbons. Other examples of electrically conductive base materials include, but not limited to, substoichiometric titanium oxides, such as, Magneli phase substoichiometric titanium oxides having the formula TiOₓ wherein x ranges from about 1.67 to about 1.9. For example, titanium oxide Ti₄O₇. In some embodiments, carbon based materials provide a mechanical support for the GDE or as blending materials to enhance electrical conductivity but may not be used as catalyst support to prevent corrosion. In some embodiments, the gas-diffusion electrodes described herein contain an electrocatalyst for aiding in electrochemical dissociation, e.g. hydrogen at the anode and reduction of oxygen at the cathode. Examples of electrocatalysts include, but not limited to, highly dispersed metals or alloys of the platinum group metals, such as platinum, palladium, ruthenium, rhodium and iridium; electrocatalytic metal oxides; organometallic macrocyclic compounds, and other electrocatalysts well known in the art for electrochemical dissociation of hydrogen or reduction of oxygen. In some embodiments, the gas-diffusion electrodes described herein, relate to porous homogeneous composite structures as well as heterogeneous, layered type composite structures wherein each layer may have a distinct physical and compositional make-up, e.g. porosity and electroconductive base to prevent flooding, and loss of the three phase interface, and resulting electrode performance.

The gas-diffusion electrodes provided herein include anodes and cathodes having porous polymeric layers on or adjacent to the anolyte solution side of the electrode which may assist in decreasing penetration and electrode fouling. Stable polymeric resins or films may be included in a composite electrode layer adjacent to the anolyte comprising resins formed from non-ionic polymers, such as polystyrene, polyvinyl chloride, polysulfone, etc., or ionic-type charged polymers like those formed from polystyrenesulfonic acid, sulfonated copolymers of styrene and vinylbenzene, carboxylated polymer derivatives, sulfonated or carboxylated polymers having partially or totally fluorinated hydrocarbon chains and aminated polymers like polyvinylpyridine. Stable microporous polymer films may also be included on the dry side to inhibit electrolyte penetration. In some embodiments, the gas-diffusion cathodes includes such cathodes known in the art that are coated with high surface area coatings of precious metals such as gold and/or silver, precious metal alloys, nickel, and the like.

In some embodiments, the electrolyte including the catholyte or the cathode electrolyte or the second electrolyte and/or the anolyte or the anode electrolyte or the first electrolyte in the systems and methods provided herein include, but not limited to, saltwater or fresh water. The saltwater includes, but is not limited to, seawater, brine, and/or brackish water. In some embodiments, the cathode electrolyte in the systems and methods provided herein include, but not limited to, seawater, freshwater, brine, brackish water, hydroxide, such as, sodium hydroxide, or combination thereof “Saltwater” is employed in its conventional sense to refer to a number of different types of aqueous fluids other than fresh water, where the term “saltwater” includes, but is not limited to, brackish water, sea water and brine (including, naturally occurring subterranean brines or anthropogenic subterranean brines and man-made brines, e.g., geothermal plant wastewaters, desalination waste waters, etc), as well as other salines having a salinity that is greater than that of freshwater. Brine is water saturated or nearly saturated with salt and has a salinity that is 50 ppt (parts per thousand) or greater. Brackish water is water that is saltier than fresh water, but not as salty as seawater, having a salinity ranging from 0.5 to 35 ppt. Seawater is water from a sea or ocean and has a salinity ranging from 35 to 50 ppt. The saltwater source may be a naturally occurring source, such as a sea, ocean, lake, swamp, estuary, lagoon, etc., or a man-made source. In some embodiments, the systems provided herein include the saltwater from terrestrial brine. In some embodiments, the depleted saltwater withdrawn from the electrochemical cells is replenished with salt and re-circulated back in the electrochemical cell.

In some embodiments, the electrolyte including the cathode electrolyte and/or the anode electrolyte, such as, saltwater includes water containing more than 1% chloride content, such as, NaCl; or more than 10% NaCl; or more than 20% NaCl; or more than 30% NaCl; or more than 40% NaCl; or more than 50% NaCl; or more than 60% NaCl; or more than 70% NaCl; or more than 80% NaCl; or more than 90% NaCl; or between 1-99% NaCl; or between 1-95% NaCl; or between 1-90% NaCl; or between 1-80% NaCl; or between 1-70% NaCl; or between 1-60% NaCl; or between 1-50% NaCl; or between 1-40% NaCl; or between 1-30% NaCl; or between 1-20% NaCl; or between 1-10% NaCl; or between 10-99% NaCl; or between 10-95% NaCl; or between 10-90% NaCl; or between 10-80% NaCl; or between 10-70% NaCl; or between 10-60% NaCl; or between 10-50% NaCl; or between 10-40% NaCl; or between 10-30% NaCl; or between 10-20% NaCl; or between 20-99% NaCl; or between 20-95% NaCl; or between 20-90% NaCl; or between 20-80% NaCl; or between 20-70% NaCl; or between 20-60% NaCl; or between 20-50% NaCl; or between 20-40% NaCl; or between 20-30% NaCl; or between 30-99% NaCl; or between 30-95% NaCl; or between 30-90% NaCl; or between 30-80% NaCl; or between 30-70% NaCl; or between 30-60% NaCl; or between 30-50% NaCl; or between 30-40% NaCl; or between 40-99% NaCl; or between 40-95% NaCl; or between 40-90% NaCl; or between 40-80% NaCl; or between 40-70% NaCl; or between 40-60% NaCl; or between 40-50% NaCl; or between 50-99% NaCl; or between 50-95% NaCl; or between 50-90% NaCl; or between 50-80% NaCl; or between 50-70% NaCl; or between 50-60% NaCl; or between 60-99% NaCl; or between 60-95% NaCl; or between 60-90% NaCl; or between 60-80% NaCl; or between 60-70% NaCl; or between 70-99% NaCl; or between 70-95% NaCl; or between 70-90% NaCl; or between 70-80% NaCl; or between 80-99% NaCl; or between 80-95% NaCl; or between 80-90% NaCl; or between 90-99% NaCl; or between 90-95% NaCl.

In some embodiments, the electrolyte including the cathode electrolyte and/or the anode electrolyte includes water containing more than 1% sulfate content or between 1-100% sulfate, such as, sodium sulfate, potassium sulfate, and the like; or more than 10% sulfate; or more than 20% sulfate; or more than 30% sulfate; or more than 40% sulfate; or more than 50% sulfate; or more than 60% sulfate; or more than 70% sulfate; or more than 80% sulfate; or more than 90% sulfate; or between 1-99% sulfate; or between 1-95% sulfate; or between 1-90% sulfate; or between 1-80% sulfate; or between 1-70% sulfate; or between 1-60% sulfate; or between 1-50% sulfate; or between 1-40% sulfate; or between 1-30% sulfate; or between 1-20% sulfate; or between 1-10% sulfate; or between 10-99% sulfate; or between 10-95% sulfate; or between 10-90% sulfate; or between 10-80% sulfate; or between 10-70% sulfate; or between 10-60% sulfate; or between 10-50% sulfate; or between 10-40% sulfate; or between 10-30% sulfate; or between 10-20% sulfate; or between 20-99% sulfate; or between 20-95% sulfate; or between 20-90% sulfate; or between 20-80% sulfate; or between 20-70% sulfate; or between 20-60% sulfate; or between 20-50% sulfate; or between 20-40% sulfate; or between 20-30% sulfate; or between 30-99% sulfate; or between 30-95% sulfate; or between 30-90% sulfate; or between 30-80% sulfate; or between 30-70% sulfate; or between 30-60% sulfate; or between 30-50% sulfate; or between 30-40% sulfate; or between 40-99% sulfate; or between 40-95% sulfate; or between 40-90% sulfate; or between 40-80% sulfate; or between 40-70% sulfate; or between 40-60% sulfate; or between 40-50% sulfate; or between 50-99% sulfate; or between 50-95% sulfate; or between 50-90% sulfate; or between 50-80% sulfate; or between 50-70% sulfate; or between 50-60% sulfate; or between 60-99% sulfate; or between 60-95% sulfate; or between 60-90% sulfate; or between 60-80% sulfate; or between 60-70% sulfate; or between 70-99% sulfate; or between 70-95% sulfate; or between 70-90% sulfate; or between 70-80% sulfate; or between 80-99% sulfate; or between 80-95% sulfate; or between 80-90% sulfate; or between 90-99% sulfate; or between 90-95% sulfate.

In some embodiments, the cathode electrolyte, such as, saltwater, fresh water, and/or sodium hydroxide do not include alkaline earth metal ions or divalent cations. As used herein, the divalent cations include alkaline earth metal ions, such as but not limited to, calcium, magnesium, barium, strontium, radium, etc. In some embodiments, the cathode electrolyte, such as, saltwater, fresh water, and/or sodium hydroxide include less than 1% w/w divalent cations. In some embodiments, the cathode electrolyte, such as, seawater, freshwater, brine, brackish water, and/or sodium hydroxide include less than 1% w/w divalent cations. In some embodiments, the cathode electrolyte, such as, seawater, freshwater, brine, brackish water, and/or sodium hydroxide include divalent cations including, but not limited to, calcium, magnesium, and combination thereof. In some embodiments, the cathode electrolyte, such as, seawater, freshwater, brine, brackish water, and/or sodium hydroxide include less than 1% w/w divalent cations including, but not limited to, calcium, magnesium, and combination thereof.

In some embodiments, the anode electrolyte includes, but not limited to, fresh water and hydrochloric acid. In some embodiments, the anode electrolyte includes, but not limited to, saltwater and hydrochloric acid. In some embodiments, the anode electrolyte includes hydrochloric acid. In some embodiments, the anode electrolyte includes sulfuric acid.

In some embodiments, the depleted saltwater from the cell may be circulated back to the cell. In some embodiments, the cathode electrolyte includes 1-90%; 1-50%; or 1-40%; or 1-30%; or 1-15%; or 1-20%; or 1-10%; or 5-90%; or 5-50%; or 5-40%; or 5-30%; or 5-20%; or 5-10%; or 10-90%; or 10-50%; or 10-40%; or 10-30%; or 10-20%; or 15-20%; or 15-30%; or 20-30%, of the sodium hydroxide solution. In some embodiments, the anode electrolyte includes 0-5 M; or 0-4.5M; or 0-4M; or 0-3.5M; or 0-3M; or 0-2.5M; or 0-2M; or 0-1.5M; or 0-1M; or 1-5M; or 1-4.5M; or 1-4M; or 1-3.5M; or 1-3M; or 1-2.5M; or 1-2M; or 1-1.5M; or 2-5M; or 2-4.5M; or 2-4M; or 2-3.5M; or 2-3M; or 2-2.5M; or 3-5M; or 3-4.5M; or 3-4M; or 3-3.5M; or 4-5M; or 4.5-5M hydrochloric acid solution or sulfuric acid solution. In some embodiments, the anode does not form an oxygen gas. In some embodiments, the anode does not form a chlorine gas.

In some embodiments, the cathode electrolyte and the anode electrolyte are separated in part or in full by an ion exchange membrane. In some embodiments, the ion exchange membrane is an anion exchange membrane or a cation exchange membrane. In some embodiments, the cation exchange membranes in the electrochemical cell, as disclosed herein, are conventional and are available from, for example, Asahi Kasei of Tokyo, Japan; or from Membrane International of Glen Rock, N.J., or DuPont, in the USA. Examples of cationic exchange membranes include, but not limited to, cationic membrane consisting of a perfluorinated polymer containing anionic groups, for example sulphonic and/or carboxylic groups. However, it may be appreciated that in some embodiments, depending on the need to restrict or allow migration of a specific cation or an anion species between the electrolytes, a cation exchange membrane that is more restrictive and thus allows migration of one species of cations while restricting the migration of another species of cations may be used as, e.g., a cation exchange membrane that allows migration of sodium ions into the cathode electrolyte from the anode electrolyte while restricting migration of hydrogen ions from the anode electrolyte into the cathode electrolyte, may be used. Similarly, in some embodiments, depending on the need to restrict or allow migration of a specific anion species between the electrolytes, an anion exchange membrane that is more restrictive and thus allows migration of one species of anions while restricting the migration of another species of anions may be used as, e.g., an anion exchange membrane that allows migration of chloride ions into the anode electrolyte from the cathode electrolyte while restricting migration of hydroxide ions from the cathode electrolyte into the anode electrolyte, may be used. Such restrictive cation and/or anion exchange membranes are commercially available and can be selected by one ordinarily skilled in the art.

In some embodiments, there is provided a system comprising one or more anion exchange membrane, and cation exchange membranes located between the anode and the cathode. In some embodiments, the membranes should be selected such that they can function in an acidic and/or basic electrolytic solution as appropriate. Other desirable characteristics of the membranes include high ion selectivity, low ionic resistance, high burst strength, and high stability in an acidic electrolytic solution in a temperature range of 0° C. to 100° C. or higher, or a alkaline solution in similar temperature range may be used. In some embodiments, a membrane that is stable in the range of 0° C. to 90° C.; or 0° C. to 80° C.; or 0° C. to 70° C.; or 0° C. to 60° C.; or 0° C. to 50° C.; or 0° C. to 40° C., or 0° C. to 30° C., or 0° C. to 20° C., or 0° C. to 10° C., or higher may be used. In some embodiments, a membrane that is stable in the range of 0° C. to 90° C.; or 0° C. to 80° C.; or 0° C. to 70° C.; or 0° C. to 60° C.; or 0° C. to 50° C.; or 0° C. to 40° C., but unstable at higher temperature, may be used. For other embodiments, it may be useful to utilize an ion-specific ion exchange membranes that allows migration of one type of cation but not another; or migration of one type of anion and not another, to achieve a desired product or products in an electrolyte. In some embodiments, the membrane may be stable and functional for a desirable length of time in the system, e.g., several days, weeks or months or years at temperatures in the range of 0° C. to 90° C.; or 0° C. to 80° C.; or 0° C. to 70° C.; or 0° C. to 60° C.; or 0° C. to 50° C.; or 0° C. to 40° C.; or 0° C. to 30° C.; or 0° C. to 20° C.; or 0° C. to 10° C., and higher and/or lower. In some embodiments, for example, the membranes may be stable and functional for at least 1 day, at least 5 days, 10 days, 15 days, 20 days, 100 days, 1000 days, 5-10 years, or more in electrolyte temperatures at 100° C., 90° C., 80° C., 70° C., 60° C., 50° C., 40° C., 30° C., 20° C., 10° C., 5° C. and more or less.

The ohmic resistance of the membranes may affect the voltage drop across the anode and cathode, e.g., as the ohmic resistance of the membranes increase, the voltage across the anode and cathode may increase, and vice versa. Membranes that can be used include, but are not limited to, membranes with relatively low ohmic resistance and relatively high ionic mobility; and membranes with relatively high hydration characteristics that increase with temperatures, and thus decreasing the ohmic resistance. By selecting membranes with lower ohmic resistance known in the art, the voltage drop across the anode and the cathode at a specified temperature can be lowered.

Scattered through membranes may be ionic channels including acid groups. These ionic channels may extend from the internal surface of the matrix to the external surface and the acid groups may readily bind water in a reversible reaction as water-of-hydration. This binding of water as water-of-hydration may follow first order reaction kinetics, such that the rate of reaction is proportional to temperature. Consequently, membranes can be selected to provide a relatively low ohmic and ionic resistance while providing for improved strength and resistance in the system for a range of operating temperatures.

The system may be configured to produce any desired pH difference between the anode electrolyte and the cathode electrolyte by modulating the pH of the anode electrolyte, the pH of the cathode electrolyte, the concentration of hydroxide in the cathode electrolyte, the concentration of acid in the anode electrolyte, the amount of hydrogen gas to the anode, the withdrawal and replenishment of the anode electrolyte, the withdrawal and replenishment of the cathode electrolyte, and/or the amount of the carbon from the source of carbon added to the cathode electrolyte. By modulating the pH difference between the anode electrolyte and the cathode electrolyte, the voltage across the anode and the cathode can be modulated. In some embodiments, the system is configured to produce a pH difference of at least 4 pH units; at least 5 pH units; at least 6 pH units; at least 7 pH units; at least 8 pH units; at least 9 pH units; at least 10 pH units; at least 11 pH units; at least 12 pH units; at least 13 pH units; at least 14 pH units; or between 4-12 pH units; or between 4-11 pH units; or between 4-10 pH units; or between 4-9 pH units; or between 4-8 pH units; or between 4-7 pH units; or between 4-6 pH units; or between 4-5 pH units; or between 3-12 pH units; or between 3-11 pH units; or between 3-10 pH units; or between 3-9 pH units; or between 3-8 pH units; or between 3-7 pH units; or between 3-6 pH units; or between 3-5 pH units; or between 3-4 pH units; or between 5-12 pH units; or between 5-11 pH units; or between 5-10 pH units; or between 5-9 pH units; or between 5-8 pH units; or between 5-7 pH units; or between 5-6 pH units; or between 7-12 pH units; or between 7-11 pH units; or between 7-10 pH units; or between 7-9 pH units; or between 7-8 pH units; or between 8-12 pH units; or between 8-11 pH units; or between 8-10 pH units; or between 8-9 pH units; or between 9-12 pH units; or between 9-11 pH units; or between 9-10 pH units; or between 10-12 pH units; or between 10-11 pH units; or between 11-12 pH units; between the anode electrolyte and the cathode electrolyte. In some embodiments, the system is configured to produce a pH difference of at least 4 pH units between the anode electrolyte and the cathode electrolyte.

In some embodiments, methods of the invention may also include determining and assessing the make-up of the produced deprotonated carbonate composition. Determining the makeup of the produced deprotonated carbonate composition refers to the analysis of one or more of the properties and/or the components present in the deprotonated carbonate composition. Determining the makeup of the produced deprotonated carbonate composition may include, but is not limited to, determining the bicarbonate concentration, the carbonate concentration, metal composition, salt composition, ionic composition, organometallic composition, organic composition, bacterial content, pH, physical properties (e.g., boiling point), electrochemical properties, spectroscopic properties, acid-base properties, polydispersities, isotopic composition, and partition coefficient of the deprotonated carbonate composition. Any convenient protocol can be employed to determine the makeup of the deprotonated carbonate composition. In some embodiments, prior to analysis, a sample of the deprotonated carbonate composition may be obtained and filtered (e.g., by vacuum filtration) to separate the solid components from the liquid components. Methods for analyzing the deprotonated carbonate composition may include, but are not limited to the use of inductively coupled plasma emission spectrometry, inductively coupled plasma mass spectrometry, ion chromatography, X-ray diffraction, gas chromatography, gas chromatography-mass spectrometry, flow-injection analysis, scintillation counting, acidimetric titration, and flame emission spectrometry.

### Low Energy

In some embodiments, the method of separating carbon dioxide gas from the multi-component gaseous stream, such as flue gas from natural-gas burning power plant, consumes an amount of energy which is less than the amount of energy generated during the production of the multi-component gaseous stream. That is, separating carbon dioxide from the multi-component gaseous stream, in some embodiments, consumes less than 100% of the energy generated by the source of the multi-component gaseous stream, such as 90% or less, such as 80% or less, such as 70% or less, such as 60% or less, such as 50% or less, such as 40% or less, such as 30% or less, such as 20% or less, such as 10% or less, such as 5% or less, such as between 5-90%, such as between 10-80%, or such as between 20-80%, or such as between 20-50%, of the energy generated from the multi-component gaseous stream. As such, the energy generated by the source of the multi-component gaseous stream may in some embodiments, be 1.5-fold or more than the amount of the energy required to separate carbon dioxide gas from the multi-component gaseous stream, such as 2-fold or more, such as 2.5-fold or more, such as 3-fold or more, such as 4-fold or more, such as 5-fold or more, such as 6-fold or more, such as 7-fold or more, such as 8-fold or more, such as 9-fold or more, including 10-fold or more than the amount of energy required to separate carbon dioxide gas from the multi-component gaseous stream.

Methods of the invention also include using proton-removing agent from the electrochemical process to convert the protonated carbonate to the deprotonated carbonate in a process that consumes less energy than the amount of energy generated during production of the multi-component gaseous stream, such as, flue gas from natural-gas burning power plant. In some embodiments, electrochemical removal of protons from the protonated carbonate composition to produce a deprotonate carbonate composition consumes an amount of energy which is less than the amount of energy generated during the production of the multi-component gaseous stream. That is, the electrochemical removal of protons from the protonated carbonate composition, in some embodiments, consumes 100% or less of the energy generated by the source of the multi-component gaseous stream, such as 90% or less, such as 80% or less, such as 70% or less, such as 60% or less, such as 50% or less, such as 40% or less, such as 30% or less, such as 20% or less, such as 10% or less, such as 5% or less, such as between 5-90%, such as between 10-80%, or such as between 20-20%, of the energy generated from the source of the multi-component gaseous stream. As such, the energy generated by the source of the multi-component gaseous stream (e.g., natural gas-burning power plant) may in some embodiments, be 1.5-fold or more than the amount of the energy required to electrochemically remove protons from the protonated carbonate composition, such as 2-fold or more, such as 2.5-fold or more, such as 3-fold or more, such as 4-fold or more, such as 5-fold or more, such as 6-fold or more, such as 7-fold or more, such as 8-fold or more, such as 9-fold or more, including 10-fold or more than the amount of energy required to electrochemically remove protons from the protonated carbonate composition.

Aspects of the invention also include, in some embodiments, determining the amount of energy consumed by separating carbon dioxide from the multi-component gaseous stream. Determining the amount of energy consumed by separating carbon dioxide from the multi-component gaseous stream refers to quantifying the amount of energy consumed by any step in separating carbon dioxide from the multi-component gaseous stream. As such, determining the energy consumption of separating carbon dioxide from the multi-component gaseous stream may include, but is not limited to, quantifying the amount of energy consumed by contacting protocols, electrochemically removing protons, heating or cooling protocols, gas pressurization protocols, temperature adjustment protocols, pumping protocols, mixing protocols, precipitation protocols, composition analysis protocols, mass transfer protocols and refinement protocols. Any convenient protocol can be employed to determine the energy consumption. Methods for quantifying the amount of energy consumed by any step in separating carbon dioxide from a multi-component gaseous stream may include, but are not limited to the use of electric meters, sensors or detectors, such as for example, electromechanical induction meters, digital electricity meters, voltmeters, current transformers, DC meters, AC megawatt hour meters, among other protocols for quantifying electricity consumption.

The amount of energy consumed by methods of the invention may be determined at any phase during the practice of the invention. For example, the amount of energy consumption may be determined before electrochemically removing protons from the protonated carbonate composition, during electrochemically removing protons from the protonated carbonate composition, or after electrochemically removing protons from the protonated carbonate composition. In some embodiments, methods also include monitoring the energy consumption throughout the entire procedure. In some embodiments, monitoring the energy consumption includes collecting real-time data (e.g., current or voltage) about energy being consumed, such as by employing one or more meters or sensors to monitor the energy consumption. In other embodiments, the energy consumption may be monitored by determining the energy usage at regular intervals, e.g., determining the energy usage every 1 minute, every 5 minutes, every 10 minutes, every 30 minutes, every 60 minutes, every 100 minutes, every 200 minutes, every 500 minutes, or some other interval.

In some embodiments, the methods may also include assessing the determined energy consumption. The assessing includes that a human (either alone or with the assistance of a computer, if using a computer-automated process initially set up under human direction), evaluates the determined energy consumption and determines whether the energy consumption requires any adjustments. If after assessing whether the determined energy consumption meets the desired levels, methods for separating carbon dioxide from the multi-component gaseous stream may continue without any further adjustments. In other words, methods of these embodiments include a step of assessing the determined energy consumption to identify any desired adjustments to the energy consumption by systems of the invention. The desired adjustments may vary in terms of goal, where in some instances the desired adjustments are adjustments that result in enhanced energy efficiency or lowered cost.

In some embodiments, where the energy consumption has been determined to be at least less than optimal the energy consumption may be adjusted. The amount of energy consumed by methods of the invention may be adjusted at any phase during the practice of the invention. For example, the amount of energy consumption may be adjusted before removing protons from the protonated carbonate composition, during removing protons from the protonated carbonate composition, or after removing protons from the protonated carbonate composition. For example, the amount of energy consumption may be adjusted before electrochemically removing protons from the protonated carbonate composition, during electrochemically removing protons from the protonated carbonate composition, or after electrochemically removing protons from the protonated carbonate composition. In some embodiments it may be determined that no adjustment to the energy consumption is desired.

The energy consumption by systems of the invention may be adjusted automatically, such as by a computer or at regular intervals, e.g., adjusting the energy to maximize energy efficiency or cost every 1 hour, every 5 hours, every 10 hours, every 24 hours, every 48 hours, or some other interval. In certain embodiments, the energy consumption by systems of the invention may be adjusted automatically in response to the energy consumption reaching or exceeding a predetermined threshold. In other embodiments, the energy consumption may be adjusted manually, such as by operating a computer interface which is configured to provide a user with parameters for controlling the energy consumption of the system.

In some embodiments, the energy consumption may be considered to be less than optimal when the energy consumption reaches or exceeds a predetermined threshold. For example, the energy consumption may be decreased when the amount of carbon dioxide produced with respect to the amount of energy generated by the power plant reaches or exceeds a predetermined threshold. In some embodiments, methods of the invention include adjusting the energy consumption when the multi-component gaseous stream is produced by a source that produces an amount of carbon dioxide per megawatt hour of energy that reaches or exceeds 0.5 tons of carbon dioxide per megawatt hour or more, such as 0.6 tons of carbon dioxide per megawatt hour or more, such as 0.7 tons of carbon dioxide per megawatt hour or more, such as 0.8 tons of carbon dioxide per megawatt hour or more, such as 0.9 tons of carbon dioxide per megawatt hour or more, including 1.0 ton of carbon dioxide per megawatt hour or more.

In other embodiments, the energy consumption may be adjusted by electrochemically removing protons from the protonated carbonate composition in part, or solely during low energy cost periods. The “low energy cost periods” includes any duration during which electricity demands may be decreased, more easily available or when electricity is less expensive. By less expensive is meant the price of electricity during low energy cost periods is reduced, such as by 1.5-fold or greater, such as 2-fold or greater, such as 2.5-fold or greater, including 5-fold or greater, e.g., as compared to when electricity prices are at their highest. For example, the price of electricity may be higher during the daytime than during the night since there is generally less electricity usage during the night than during the daytime. As such, methods of the invention may include adjusting the energy consumption by systems of the invention depending on the availability, demand or price of electricity. For example, electrochemical methods for removing protons from the protonated carbonate may be adjusted to employ lower voltage electrochemical protocols when electricity prices are highest and employing higher voltage electrochemical protocols when electricity prices are lower. For example, electrochemical methods applying voltages of 1.0 V or less, such as 0.9 V or less, such as 0.8 V or less, such as 0.7 V or less, such as 0.6 V or less, such as 0.5 V or less, such as 0.4 V or less, such as 0.3 V or less, such as 0.2 V or less, such as 0.1 V or less may be employed only during peak energy cost periods (e.g., during the daytime), while electrochemical methods applying voltages of 1.0 V or more, such as 1.1 V or more, such as 1.2 V or more, such as 1.3 V or more, such as 1.4 V or more, such as 1.5 V or more, including 2.0 V or more may only be employed during low energy cost periods (e.g., during the night).

In some embodiments, the energy consumption may be adjusted by employing a renewable energy protocol to provide a portion or all of the energy to systems of the invention. As such, 10% or more of the required energy by systems of the invention may be provided by renewable energy protocols, such as 20% or more, such as 25% or more, such as 30% or more, such as 40% or more, such as 50% or more, such as 60% or more, such as 70% or more, such as 75% or more, such as 80% or more, such as 90% or more, such as 95% or more, such as 99% or more, or between 20-90%, of the required energy by systems of the invention may be provided by renewable energy protocols. The “renewable energy protocol” is used in its conventional sense to include any energy protocol which employs a renewable source of energy to produce usable power, such as in the form of electricity or heat. In certain embodiments, renewable energy protocols are sources of energy that produce little to no carbon dioxide. As such, renewable energy protocols of the invention may produce 0.05 tons of carbon dioxide per megawatt hour of energy or less, such as 0.01 tons of carbon dioxide per megawatt hour of energy or less, such as 0.005 tons of carbon dioxide per megawatt hour of energy or less, such as 0.001 tons of carbon dioxide per megawatt hour of energy or less, such as 0.0005 tons of carbon dioxide per megawatt hour of energy or less, such as 0.0001 tons of carbon dioxide per megawatt hour of energy or less, including 0.000001 tons of carbon dioxide per megawatt hour of energy or less. In some embodiments, renewable energy power plants are solar power plants, gas compression power plants, light-harvesting arrays, wind-harvesting power plants, windmill arrays, or any combination thereof.

### Sequestration and Formation of Carbonate-Containing Precipitation Material

The methods disclosed herein include contacting a multi-component gaseous stream, such as flue gas from a natural gas-burning power plant, with an aqueous composition to produce a protonated carbonate composition where some or all of the CO₂ in the multi-component gaseous stream contacted with the aqueous composition is converted to carbonic acid or bicarbonate. Further, methods of the invention include removing protons from the protonated carbonate composition to produce a deprotonated carbonate composition. In some embodiments, methods of the invention also include producing a carbonate-containing precipitation material from the deprotonated carbonate composition or sequestering the produced deprotonated carbonate composition (e.g., conveying to a sequestration location).

In some embodiments, methods include assessing and regulating the amount of deprotonated carbonate composition that is sequestered and the amount of deprotonated carbonate composition that is employed in producing a carbonate-containing precipitation material. In some instances, the amount of the deprotonated carbonate composition sequestered may be 1% or greater of the produced deprotonated carbonate composition, such as 5% or greater, such as 10% or greater, such as 25% or greater, such as 50% or greater, such as 75% or greater, such as 90% or greater, such as 95% or greater, and including 99% or greater of the produced deprotonated carbonate composition. In these instances, the remainder of the deprotonated carbonate composition may be employed to produce a carbonate-containing precipitation material or alternatively, may be employed for some other function, as desired, e.g., acid-neutralization protocols. As such, the molar ratio of deprotonated carbonate composition that is sequestered to deprotonated carbonate composition that is employed to produce a carbonate-containing precipitation material may vary, and in some instances may range between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the molar ratio of deprotonated carbonate composition that is sequestered to deprotonated carbonate composition that is employed to produce a carbonate-containing precipitation material may range between 1:1 and 1:10; 1:5 and 1:25; 1:10 and 1:50; 1:25 and 1:100; 1:50 and 1:500; or 1:100 and 1:1000. In other embodiments, the molar ratio of deprotonated carbonate composition that is employed to produce a carbonate-containing precipitation material to deprotonated carbonate composition that is sequestered ranges between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the molar ratio of deprotonated carbonate composition that is employed to produce a carbonate-containing precipitation material to deprotonated carbonate composition that is sequestered may range between 1:1 and 1:10; 1:5 and 1:25; 1:10 and 1:50; 1:25 and 1:100; 1:50 and 1:500; or 1:100 and 1:1000.

In some embodiments, methods of the invention also include processing the deprotonated carbonate composition prior to employing the deprotonated carbonate composition to produce a carbonate-containing precipitation material or conveying the deprotonated carbonate composition to a sequestration location.

In some embodiments, processing the deprotonated carbonate includes adjusting (e.g., increasing or decreasing) the concentration of bicarbonate or carbonate in the deprotonated carbonate composition. In some embodiments, the bicarbonate concentration in the deprotonated carbonate composition is increased. For example, the bicarbonate concentration in the deprotonated carbonate composition may be increased by 0.1 M or more, such as by 0.5 M or more, such as by 1 M or more, such as by 2 M or more, such as by 5 M or more, including by 10 M or more. In some embodiments, bicarbonate is concentrated to a concentration of 0.5 M or greater, such as 1.0 M or greater, such as 1.5 M or greater, such as 2.0 M or greater, such as 2.5 M or greater, such as 5.0 M or greater, such as 7.5 M or greater, including 10 M or greater. In other embodiments, the carbonate concentration in the deprotonated carbonate composition is increased. For example, the carbonate concentration in the deprotonated carbonate composition may be increased by 0.1 M or more, such as by 0.5 M or more, such as by 1 M or more, such as by 2 M or more, such as by 5 M or more, including by 10 M or more. In some embodiments, carbonate is concentrated to a concentration of 0.5 M or greater, such as 1.0 M or greater, such as 1.5 M or greater, such as 2.0 M or greater, such as 2.5 M or greater, such as 5.0 M or greater, such as 7.5 M or greater, including 10 M or greater. Concentrating bicarbonate or carbonate in the deprotonated carbonate composition may be accomplished using any convenient protocol, e.g., distillation, evaporation, or even adding bicarbonate or carbonate to the deprotonated carbonate composition, among other protocols.

In other embodiments, the methods may include decreasing the bicarbonate concentration in the deprotonated carbonate composition. As such, the concentration of bicarbonate in the deprotonated carbonate composition may be decreased, e.g., by 0.1M or more, such as by 0.5 M or more, such as by 1 M or more, such as by 2 M or more, such as by 5 M or more, including by 10 M or more. In certain embodiments, the methods include decreasing the concentration of bicarbonate in the deprotonated carbonate composition to a concentration that is 5 M or less, such as 2 M or less, such as 1 M or less, including 0.5 M or less. In yet other embodiments, the methods include decreasing the carbonate concentration in the deprotonated carbonate composition. As such, the concentration of carbonate in the deprotonated carbonate composition may be decreased, e.g., by 0.1M or more, such as by 0.5 M or more, such as by 1 M or more, such as by 2 M or more, such as by 5 M or more, including by 10 M or more. In certain embodiments, the methods include decreasing the concentration of carbonate in the deprotonated carbonate composition to a concentration that is 5 M or less, such as 2 M or less, such as 1 M or less, including 0.5 M or less. Decreasing the concentration of the deprotonated carbonate composition may be accomplished using any convenient protocol, e.g., diluting the deprotonated carbonate composition with diluent (e.g., water) to the deprotonated carbonate composition, among other protocols.

In some embodiments, processing the deprotonated carbonate composition includes adjusting the temperature of the deprotonated carbonate composition. For example, the temperature of the deprotonated carbonate composition may be adjusted (i.e., increased or decreased) as desired, e.g., by 5° C. or more, such as 10° C. or more, such as 15° C. or more, such as 25° C. or more, such as 50° C. or more, such as 75° C. or more, including 100° C. or more. Where the deprotonated carbonate composition is to be sequestered, the temperature of the deprotonated carbonate composition may be adjusted to a temperature which is equivalent to the internal temperature of the sequestration location. The temperature of the deprotonated carbonate composition may be adjusted using any convenient protocol, such as for example a thermal heat exchanger, electric heating coils, Peltier thermoelectric devices, gas-powered boilers, among other protocols. In certain embodiments, the temperature may be raised using energy generated from low or zero carbon dioxide emission sources, e.g., solar energy source, wind energy source, hydroelectric energy source, etc.

Processing the deprotonated carbonate composition may also include pressurizing the deprotonated carbonate composition. The “pressurizing” is used in its conventional sense and includes increasing the ambient pressure on the deprotonated carbonate composition. Accordingly, the ambient pressure may be increased by 0.1 atm or more, such as 0.05 atm or more, such as 1 atm or more, such as 5 atm or more, such as 10 atm or more, such as 25 atm or more, such as 50 atm or more, and including 100 atm or more. In some instances, the bicarbonate composition is pressurized to a pressure that is greater than atmospheric pressure, e.g., 1.5 atm or greater, such as 2 atm or greater, such as 5 atm or greater, such as 10 atm or greater, such as 25 atm or greater, such as 50 atm or greater, including 100 atm or greater. Where the deprotonated carbonate composition is be sequestered, the deprotonated carbonate composition may be pressurized to a pressure that is equivalent to the internal pressure within the sequestration location. The deprotonated carbonate composition may be pressurized using any convenient fluid compression protocol. In some embodiments, pressurizing the deprotonated carbonate composition may employ positive displacement pumps (e.g., piston or gear pumps), static or dynamic fluid compression protocols, radial flow centrifugal-type compressors, helical blade-type compressors, rotary compressors, reciprocating compressors, liquid-ring compressors, among other types of fluid compression protocols.

The amount of the deprotonated carbonate composition sequestered or employed to produce a carbonate-containing precipitation material may be regulated by any convenient protocol. In some embodiments, regulating the amount of deprotonated carbonate composition sequestered or employed to produce a carbonate-containing precipitation material includes regulating the output flow of the deprotonated carbonate composition from the deprotonated carbonate composition production reactor (e.g., CO₂-contacting reactor). In embodiments of the invention, the output of the deprotonated carbonate composition from the deprotonated carbonate composition production reactor is adjustable at any time. The “adjustable” includes that the intended destination (e.g., sequestration location, carbonate-containing precipitation material production plant, etc.) and amount of deprotonated carbonate composition conveyed from the deprotonated carbonate composition production reactor can be changed or modified at any time. The output of the deprotonated carbonate composition may be adjusted using any convenient protocol, such as for example, a manual control valve, a mechanical control valve, a digital control valve, a flow-control valve system, a flow regulator, or any other convenient protocol. In some instances, controlling the output of the deprotonated carbonate composition to a sequestration location or to a carbonate-containing precipitation material production plant may include employing a computer (where the flow regulator is computer-assisted or controlled entirely by a computer) that is configured to provide a user with input and output parameters to control the output of the deprotonated carbonate composition from the deprotonated carbonate composition production reactor.

Aspects of the invention also include methods for sequestering the deprotonated carbonate composition. In some embodiments, some or all of the deprotonated carbonate composition may be sequestered, such as for example by introducing and maintaining the deprotonated carbonate composition in a sequestration location. The “maintaining” the deprotonated carbonate composition in a sequestration location includes that the deprotonated carbonate composition is maintained in the sequestration location after introduction without significant, if any, degradation for extended durations, e.g., 1 year or longer, 5 years or longer, 10 years or longer, 25 years or longer, 50 years or longer, 100 years or longer, 250 years or longer, 1000 years or longer, 10,000 years or longer, 1,000,000 years or longer, or 100,000,000 years or longer, or 1,000,000,000 years or longer. In some embodiments, 1% or greater of the deprotonated carbonate composition may be sequestered, such as 5% or greater of the deprotonated carbonate composition, such as 10% or greater of the deprotonated carbonate composition, such as 25% or greater of the deprotonated carbonate composition, such as 50% or greater of the deprotonated carbonate composition, such as 75% or greater of the deprotonated carbonate composition, such as 90% or greater of deprotonated carbonate composition, such as 95% or greater of the deprotonated carbonate composition, and including 99% or greater of the deprotonated carbonate composition.

Any convenient sequestration location may be employed. In certain embodiments, the deprotonated carbonate composition may be sent to a tailings pond or may be stored in a man-made above or underground storage facility. In certain embodiments, the deprotonated carbonate composition produced by methods of the invention may be stored in a temporary storage location prior to disposal in a long term sequestration location. For example, the deprotonated carbonate composition may be temporarily stored for a period of time ranging from 1 to 1000 days or longer, such as 1 to 10 days or longer, including 1 to 100 days or longer. In other embodiments, the deprotonated carbonate composition may be conveyed to the sequestration location directly from the deprotonated carbonate composition production reactor (i.e., CO₂-contacting reactor). Any convenient protocol for transporting the deprotonated carbonate composition to the sequestration location may be employed, and will vary depending on the relative locations of the deprotonated carbonate composition production reactor and the sequestration location. In certain embodiments, a pipeline or analogous conveyance structure is employed, where approaches may include active pumping, gravitational mediated flow, etc., as desired.

In some embodiments, the sequestration location is a subterranean formation. The “subterranean formation” includes a geological formation found in a location which is below ground level, i.e., a region located beneath the Earth's surface. As such, subterranean formations of the invention may be a deep geological aquifer or an underground well located in the sedimentary basins of a petroleum field, a subterranean metal ore, a geothermal field, or an oceanic ridge, among other underground locations. In some embodiments, the subterranean formation may be spent oil wells, salt domes, abandoned mines (e.g., coal mines), lava tubes or other hollow underground geological chambers. In some embodiments, the subterranean formation may be the location from which a subterranean brine was obtained. Where the sequestration location is a subterranean formation, the subterranean formation may be located 100 m or deeper below ground level, such as 200 m or deeper below ground level, such as 300 m or deeper below ground level, such as 400 m or deeper below ground level, such as 500 m or deeper below ground level, such as 600 m or deeper below ground level, such as 700 m or deeper below ground level, such as 800 m or deeper below ground level, such as 900 m or deeper below ground level, such as 1000 m or deeper below ground level, such as 1500 m or deeper ground level, such as 2000 m or deeper below ground level, such as 2500 m or deeper below ground level, and including 3000 m or deeper below ground level.

Where desired, the deprotonated carbonate composition may be processed prior to or during conveyance into the sequestration location. For example, the volume of the deprotonated carbonate composition may be reduced before conveyance into the sequestration location, such as by evaporation or concentrating the components in the deprotonated carbonate composition. In other instances, the pressure, temperature or composition of the deprotonated carbonate composition may be adjusted, as described above. In yet other instances, it may be determined that no adjustment to the deprotonated carbonate composition is desired and the deprotonated carbonate composition may be conveyed into the sequestration location without further adjustment.

Methods and systems for introducing and maintaining a composition in a sequestration location may include, but are not limited, those described in U.S. patent application Ser. No. 12/344,019, filed 24 Dec. 2008; U.S. Provisional Patent Application No. 61/264,564, filed 25 Nov. 2009; and U.S. Provisional Patent Application No. 61/305,375, filed 16 Feb. 2010, the disclosures of which are incorporated herein by reference in their entirety.

Aspects of the invention also include methods for producing a carbonate-containing precipitation material from the deprotonated carbonate composition. Some or all of the deprotonated carbonate composition may be employed in producing a carbonate-containing precipitation material. In some embodiments, 1% or greater of the deprotonated carbonate composition may be employed in producing a carbonate-containing precipitation material, such as 5% or greater of the deprotonated carbonate composition, such as 10% or greater of the deprotonated carbonate composition, such as 25% or greater of the deprotonated carbonate composition, such as 50% or greater of the deprotonated carbonate composition, such as 75% or greater of the deprotonated carbonate composition, such as 90% or greater of deprotonated carbonate composition, such as 95% or greater of the deprotonated carbonate composition, and including 99% or greater of the deprotonated carbonate composition.

Where a portion or all of the deprotonated carbonate composition is bicarbonate (HCO₃⁻), producing a carbonate-containing precipitation material from the deprotonated carbonate composition may include contacting the deprotonated carbonate composition with an amount of one or more proton-removing agents. As described above, depending on the alkalinity of the aqueous composition, the deprotonated carbonate composition may be a mixture of bicarbonate and carbonate. For example, the molar ratio of bicarbonate to carbonate (HCO₃⁻/CO₃²⁻) in the deprotonated carbonate composition may vary, e.g., 1/1 or greater, such as 2/1 or greater, such as 5/1 or greater, such as 10/1 or greater, such as 50/1 or greater, such as 100/1 or greater, such as 1000/1 or greater, such as 10,000/1 or greater, such as 100,000/1 or greater, including 1,000,000/1 or greater. As such, the amount of proton-removing agent added to the deprotonated carbonate composition to produce substantially all carbonate (CO₃²⁻) may vary.

In some embodiments, the one or more proton-removing agent is a strong base. As described above, “base” is used in its conventional sense and includes a chemical base which fully ionizes in an aqueous solution. In some instances, the proton removing agent is a metal oxide (e.g., calcium oxide (CaO), magnesium oxide (MgO), strontium oxide (SrO), beryllium oxide (BeO), barium oxide (BaO), etc.) or is a metal hydroxide (e.g., sodium hydroxide (NaOH), potassium hydroxide (KOH), calcium hydroxide (Ca(OH)₂), magnesium hydroxide (Mg(OH)₂, etc.). In certain embodiments, the proton removing agent is an electrochemical method for removing protons in solution. Electrochemical methods for removing protons from bicarbonate with which may be employed in practicing methods of the present invention may include, but are not limited to those described in detail above and those described in U.S. patent application Ser. No. 12/344,019, filed 24 Dec. 2008; U.S. patent application Ser. No. 12/375,632, filed 23 Dec. 2008, International Patent Application No. PCT/US08/088,242, filed 23 Dec. 2008; International Patent Application No. PCT/US09/32301, filed 28 Jan. 2009; International Patent Application No. PCT/US09/48511, filed 24 Jun. 2009; U.S. patent application Ser. No. 12/541,055 filed 13 Aug. 2009; and U.S. patent application Ser. No. 12/617,005, filed 12 Nov. 2009, the disclosures of which are incorporated herein by reference in their entirety. Combinations of any of the above mentioned sources of proton-removing agents and methods for effecting proton removal may also be employed.

In some embodiments, producing a carbonate-containing precipitation material from the deprotonated carbonate composition includes contacting the deprotonated carbonate composition with a source of one or more divalent cations. Divalent cations may be obtained from any convenient source. For example, the divalent cation source may include, but is not limited to industrial wastes, mining wastes; fossil fuel burning ash (e.g., combustion ash such as fly ash, bottom ash, boiler slag); slag (e.g. iron slag, phosphorous slag); cement kiln waste; oil refinery/petrochemical refinery waste (e.g. oil field and methane seam brines); coal seam wastes (e.g. gas production brines and coal seam brine); paper processing waste; water softening waste brine (e.g., ion exchange effluent); silicon processing wastes; agricultural waste; metal finishing waste; high pH textile waste; and caustic sludge, seawater, brines (e.g., naturally occurring brines or anthropogenic brines such as geothermal plant wastewaters, desalination plant waste waters), brackish waters, hard waters, rocks and minerals (e.g., lime, periclase, material comprising metal silicates such as serpentine and olivine). Combinations of any of the above mentioned sources of divalent cations may also be employed. In certain embodiments, the amount of divalent cations contacted with the deprotonated carbonate composition ranges from 0.01 to 100.0 grams/liter of deprotonated carbonate composition, such as from 1 to 100 grams/liter of deprotonated carbonate composition, for example 5 to 80 grams/liter of deprotonated carbonate composition, including 5 to 50 grams/liter of deprotonated carbonate composition.

Where a portion or all of the deprotonated carbonate composition is bicarbonate (HCO₃⁻), the source of one or more proton-removing agents and the source of one or more divalent cations may be contacted with the deprotonated carbonate composition in any order while practicing methods of the invention. In some instances, the deprotonated carbonate composition is contacted with the proton removing agent and the divalent cations simultaneously. In other instances, the deprotonated carbonate composition is contacted with the proton removing agent and the divalent cations sequentially. In certain instances, a first portion of the deprotonated carbonate composition may be contacted with the proton removing agent and the divalent cations simultaneously and a second portion of the deprotonated carbonate composition may be contacted with the proton removing agent and the divalent cations sequentially.

Contacting the deprotonated carbonate composition with a source of one or more proton removing agents and a source of one or more divalent cations produces a carbonate-containing reaction mixture. In some embodiments, methods include subjecting the carbonate-containing reaction mixture to precipitation conditions to produce a carbonate-containing precipitation material and a depleted aqueous composition. The carbonate-containing precipitation material of the invention includes precipitated crystalline and/or amorphous carbonate compounds. The carbonate compound compositions of the invention may include metastable carbonate compounds (e.g., CaCO₃). Some carbonate-containing precipitation materials may include, but are not limited to: calcium carbonate minerals, magnesium carbonate minerals, sodium carbonate minerals, sodium bicarbonate minerals, sodium bicarbonate carbonate minerals and calcium magnesium carbonate minerals. Calcium carbonate minerals may include, but are not limited to: calcite (CaCO₃), aragonite (CaCO₃), vaterite (CaCO₃), ikaite (CaCO₃.6H₂O), and amorphous calcium carbonate (CaCO₃.nH₂O). Magnesium carbonate minerals may include, but are not limited to magnesite (MgCO₃), barringtonite (MgCO_{3′2}H₂O), nesquehonite (MgCO₃.nH₂O), lanfordite (MgCO₃.5H₂O), hydromagnisite, and amorphous magnesium calcium carbonate (MgCO₃.nH₂O). Sodium minerals may include, but are not limited to trona (Na₃(HCO₃)(CO₃)), sodium bicarbonate (NaHCO₃) and sodium carbonate (Na₂CO₃). Calcium magnesium carbonate minerals of interest include, but are not limited to dolomite (CaMgCO₃), huntitte (CaMg(CO₃)₄) and sergeevite (Ca₂Mg₁₁(CO₃)₁₃.H₂O). The carbonate compounds of the product may include one or more waters of hydration, or may be anhydrous.

The carbonate-containing reaction mixture may be subjected to carbonate compound precipitation conditions one or more times, sufficient to produce a carbonate-containing precipitation material and a depleted aqueous composition.

Any convenient precipitation conditions may be employed, which conditions result in the production of a carbonate-containing precipitation material and a depleted aqueous composition. For example, precipitation conditions to produce a carbonate-containing precipitation material from the carbonate-containing reaction mixture include, in certain embodiments, adjusting the temperature, pH or concentration of proton removing agents and divalent cations. Precipitation conditions may also include adjusting parameters such as mixing rate, forms of agitation such as ultrasonics, and the presence of seed crystals, catalysts, membranes, or substrates. In some embodiments, precipitation conditions include employing supersaturated conditions or concentration gradients, or cycling or changing any of these parameters. The protocols employed to prepare a carbonate-containing precipitation material according to the invention may be batch or continuous protocols. It will be appreciated that precipitation conditions may be different to produce a given precipitation material in a continuous flow system compared to a batch system.

Contacting the deprotonated carbonate composition with a source of one or more proton removing agents and a source of one or more divalent cations may occur before or during the time when the carbonate-containing reaction mixture is subjected to precipitation conditions. Accordingly, embodiments of the invention include methods in which the deprotonated carbonate composition may be contacted with a source of one or more proton removing agents and a source of one or more divalent cations prior to subjecting the deprotonated carbonate composition to precipitation conditions. Embodiments of the invention also include methods in which the bicarbonate composition may be contacted with a source of one or more proton removing agents and a source of one or more divalent cations while the deprotonated carbonate composition is being subjected to precipitation conditions. Embodiments of the invention also include methods in which the deprotonated carbonate composition may be contacted with a source of one or more proton removing agents and a source of one or more divalent cations both prior to and at the same time as subjecting the deprotonated carbonate composition to precipitation conditions.

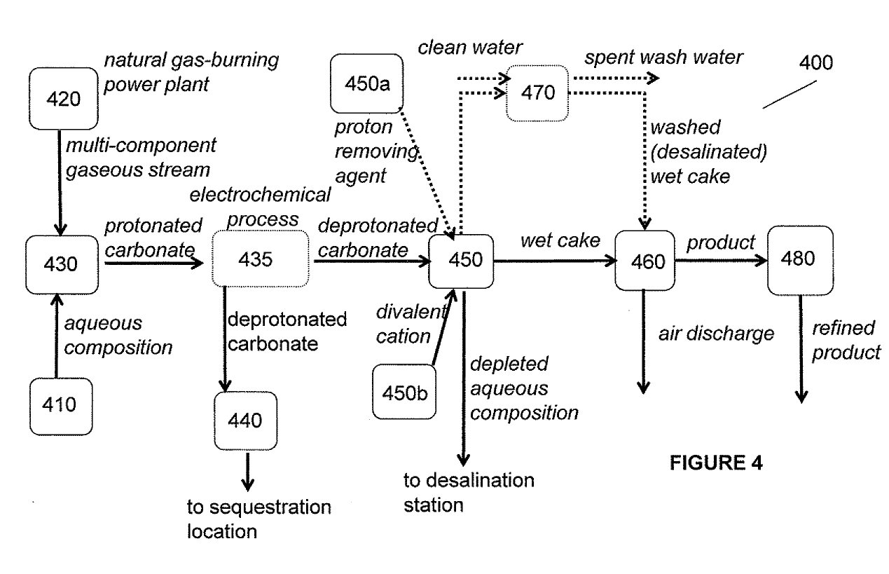

In some embodiments, as illustrated in FIG. 4, in the method 400 an aqueous composition source 410 is contacted with the multi-component gaseous stream, such as flue gas from a natural-gas burning power plant to produce a protonated carbonate composition. As described above, depending on the alkalinity of the aqueous composition, the protonated carbonate composition may contain bicarbonate and carbonic acid. As illustrated in FIG. 4, the CO₂-containing multi-component gaseous stream 420 is contacted with the aqueous composition at step 430. The provided multi-component gaseous stream 420 is contacted with one or more suitable aqueous compositions at step 430 to produce a protonated carbonate composition. Producing a protonated carbonate in this step results in separating the CO₂ content from the multi-component gaseous stream, e.g., in the form of carbonic acid and bicarbonate, and a concomitant decrease in the pCO₂ of the multi-component gaseous stream that is contacted with the aqueous composition. In certain embodiments, the concentration of CO₂ in the multi-component gaseous stream may be decreased by 10% or more, such as 25% or more, such as 50% or more, such as 75% or more, such as 90% or more, such as 95% or more and including 99% or more. Protocols for contacting the multi-component gaseous stream with the aqueous composition may be any convenient protocol, as described in detail herein.

At step 435, protons from the produced protonated carbonate composition may be removed to produce a deprotonated carbonate composition. It is to be understood that the proton-removing agent obtained from the electrochemical process illustrated in FIG. 4, is for illustration purposes only and other proton-removing agents or combination thereof, as described herein, may also be employed in the methods of the invention. In some embodiments, the protons may be removed by contacting the protonated carbonate with hydroxide produced by an electrochemical process. In some embodiments, the protonated carbonate composition is delivered to the cathode electrolyte in the cathode chamber to form deprotonated carbonate. In still some embodiments, the protonated carbonate composition may be treated with the cathode electrolyte outside of the cathode chamber where the deprotonated carbonate composition is then delivered back to the cathode electrolyte in the cathode chamber forming a loop. The cathode electrolyte may be withdrawn from the cathode chamber at any point in time to procure deprotonated carbonate composition. As described above, depending on the make-up of the protonated carbonate composition and employed electrochemical protocol, the produced deprotonated carbonate composition may contain carbonate and bicarbonate. The produced deprotonated carbonate composition may be sequestered 440 (e.g., by conveyance to a sequestration location) or may be conveyed to a carbonate-containing precipitation material production station 450 to be further employed to produce a carbonate-containing precipitation material. In some instances, a first portion of the deprotonated carbonate composition is sequestered and a second portion is employed to produce a carbonate-containing precipitation material. The amount of the deprotonated carbonate composition that may be sequestered or employed to produce a carbonate-containing precipitation material is adjustable at any time during methods of the invention, and may be adjusted in some embodiments, by a manually controlled valve, mechanical control valve, flow regulators, or any other convenient protocol. In some instances, the amount of the deprotonated carbonate composition that may be sequestered or employed to produce a carbonate-containing precipitation material may be controlled by a computer interface which is configured to provide a user with parameters for controlling the amount of the deprotonated carbonate composition that is sequestered and the amount of the deprotonated carbonate composition that is employed to produce a carbonate-containing precipitation material.

At step 440, the deprotonated carbonate composition may be sequestered, such as by conveyance to a sequestration location. The sequestration location may be a man-made above or underground storage facility or may be naturally-occurring storage location, such as a subterranean formation. At step 440, the deprotonated carbonate composition may be conveyed to the sequestration location, such as by a pipeline or other analogous conduit by active pumping, gravitational mediated flow, etc. as desired.

At step 450, the deprotonated carbonate composition may alternatively or in addition being sequestered, be employed to produce a carbonate-containing precipitation material. As illustrated in FIG. 4, where a portion or all of the deprotonated carbonate composition is bicarbonate, a source of one or more proton removing agents 450a may be contacted with the deprotonated carbonate composition prior to contacting the deprotonated carbonate composition with a source of one or more divalent cations. A source of one or more divalent cations 450b may also be contacted with the deprotonated carbonate composition at step 450 and subjected to precipitation conditions to produce a carbonate-containing precipitation material (e.g., amorphous or crystalline).

As described herein, precipitation conditions of interest include those that change the physical environment to produce the desired precipitation material. For example, the temperature of the water may be raised to an amount suitable for precipitation of the desired carbonate compound(s) to occur. In such embodiments, the temperature of the water may be raised to a value from 5 to 70° C., such as from 20 to 50° C. and including from 25 to 45° C. As such, while a given set of precipitation conditions may have a temperature ranging from 0 to 100° C., the temperature may be raised in certain embodiments to produce the desired precipitation material. In certain embodiments, the temperature may be raised using energy generated from low or zero carbon dioxide emission sources, e.g., solar energy source, wind energy source, hydroelectric energy source, etc. While the pH of the carbonate-containing reaction mixture may range from 7 to 14 during a given precipitation process, in certain of these embodiments, the pH may be raised to a level that minimizes if not eliminates CO₂ gas generation production during precipitation. In these embodiments, the pH may be 10 or higher, such as 11 or higher. As described above, the pH may be adjusted using any convenient approach. In certain embodiments, a pH-raising agent may be employed, such as oxides (sodium oxide, potassium oxide), hydroxides (e.g., sodium hydroxide, potassium hydroxide, brucite), and the like. Alternatively, the pH may be adjusted to a desired level by an electrochemical protocol.

Each of the above described steps, in part or as a whole, may occur as a continuous process or as separate distinct steps. For example, after contacting the aqueous composition with CO₂-containing multi-component gaseous stream to produce a protonated carbonate composition, protons from the protonated carbonate composition may be removed to produce a deprotonated carbonate composition, followed immediately with contacting the deprotonated carbonate composition with a source of one or more divalent cations and subjected to precipitation conditions to produce a carbonate-containing precipitation material in the same reactor. Alternatively, the deprotonated carbonate composition may be conveyed to a separate contacting reactor before contacting with the source of one or more divalent cations. In another example, the deprotonated carbonate composition produced by contacting an aqueous composition with a source of CO₂-containing multi-component gaseous stream and removing protons from the protonated carbonate composition may be conveyed directly to a sequestration location from the CO₂ contacting reactor, such as by a pipeline or other analogous conduit. Alternatively, the deprotonated carbonate composition may be produced and subsequently transported to a pumping station for conveyance to the sequestration location.

In some embodiments, following production of the carbonate-containing precipitation material, the resultant slurry of carbonate-containing precipitation material and depleted aqueous composition may be disposed of in a manner sufficient to sequester the components present in the slurry. In certain embodiments, the slurry may be disposed of directly from the production reactor such as by a pipeline, conduit or other conveyance structure. In some instances, the slurry of carbonate-containing precipitation material may be sequestered in the same sequestration location as the deprotonated carbonate composition, as described in detail above. In other embodiments, the slurry may be manually removed from inside of the reactor, such as when the reaction is produced in a contacting reactor that does not have an output conduit.

While in certain embodiments the slurry of carbonate-containing precipitation material and depleted aqueous composition is sequestered without further processing following precipitation, in yet other embodiments, the slurry may be further processed prior to disposal.

In some embodiments, following production of the carbonate-containing precipitation material, the resultant slurry of carbonate-containing precipitation material (i.e., resultant CO₂-sequestering component) and depleted brine may be separated to produce separated carbonate-containing precipitation material and depleted aqueous composition. In this step, any convenient dewatering protocol may be employed, e.g., as described above, to produce a dewatered precipitation material. In some embodiments, the resultant dewatered precipitation material may be further dried. In some embodiments, the dewatered precipitation material may be more than 5% water, more than 10% water, more than 20% water, more than 30% water, more than 50% water, more than 60% water, more than 70% water, more than 80% water, more than 90% water, or more than 95% water. As described herein, separation of the precipitation material may be achieved using any convenient approach. For example, the precipitation may be separated by a mechanical approach, e.g., where bulk excess water is drained from the precipitation material, e.g., either by gravity alone or with the addition of vacuum, mechanical pressing, by filtering the precipitation material from the mother liquor to produce a filtrate, etc. Further, the resultant dewatered precipitation material may also be dried to produce a product, as illustrated at step 460 of FIG. 4. Drying may be achieved by air-drying the filtrate. Where the filtrate is air dried, air-drying may be at room or elevated temperature. Dewatered precipitation material may be air dried to produce a precipitation material that may be less than 50% water, less than 40% water, less than 30% water, less than 20% water, less than 10% water, or less than 5% water. For example, dewatered precipitation material may be air dried to produce a precipitation material that is 30% or less water. Drying may also be achieved by spray drying the precipitation material, where the liquid containing the precipitation material is dried by feeding it through a hot gas (such as the gaseous waste stream from the power plant), e.g., where the liquid feed is pumped through an atomizer into a main drying chamber and a hot gas is passed as a co-current or counter-current to the atomizer direction. Depending on the particular drying protocol of the system, the drying station may include a filtration element, freeze drying structure, spray drying structure, etc.

Where desired, the dewatered precipitation material from liquid-solid separation may be washed before drying, as illustrated at optional step 470 of FIG. 4. The precipitation material may be washed with freshwater, e.g., to remove salts (such as NaCl) from the dewatered precipitation material. In certain embodiments, the precipitate can be separated, washed, and dried in the same station for all processes, or in different stations for all processes or any other possible combination. For example, in one embodiment, the precipitation and separation may occur in the reactor for contacting the deprotonated carbonate composition with a source of divalent cations, but drying and washing occur in different reactors. In yet another embodiment, precipitation, separation, and drying may occur all in the same reactor and washing occurring in a different reactor.

The dried product may be disposed of in a number of different ways, such as for example in the manner as described herein. For example, the precipitate product may be transported to an above-ground location for long term storage, effectively sequestering CO₂ in a stable precipitated product, e.g., as a storage stable above ground CO₂ sequestering material.

In some embodiments, as depicted at step 480 of FIG. 4, the dried precipitation material may optionally be refined, e.g., mechanical refinement such as grinding, to provide for desired physical characteristics, such as particle size, surface area, etc. As described herein, the carbonate-containing precipitation material produced by methods of the invention may be employed as a building material, such as for example in hydraulic cements, formed building materials (e.g., brick), supplementary cementitious materials, aggregate or may be employed as a component of a non-cementitious composition, such as for example a paper product, a polymeric product (e.g., plastics), a lubricant, an adhesive, a rubber product, chalk, asphalt products, paint, personal-care products (toothpaste), cleaning products, ingestible products (e.g., food vitamins, nutritional supplements, pharmaceuticals), environmental remediation product (e.g., oceanic acidification neutralizer).

Separation of the carbonate-containing precipitation material from the carbonate-containing reaction mixture provides a depleted aqueous composition. As illustrated in FIG. 4, aspects of the invention also include desalinating the depleted aqueous composition to produce desalinated water and an effluent aqueous composition. In certain embodiments, following production of the carbonate-containing precipitation material from the deprotonated carbonate composition, the resultant carbonate-containing precipitation material is separated to produce a depleted aqueous composition, which can be used as feed water for desalination. As described herein, desalination of the depleted aqueous composition can be achieved using any convenient approach, such as for example distillation, e.g., multi-stage flash distillation (MSF), multiple effect evaporator (MED/ME), vapor-compression evaporation (VC) and evaporation/condensation, ion exchange methods, membrane processes, e.g., electrodialysis reversal (EDR), reverse osmosis (RO), nanofiltration (NF), forward osmosis (FO), membrane distillation (MD), where excess salt and other minerals are removed from the depleted aqueous composition.

The amount of carbon and oxygen present in products produced (e.g., protonated carbonates, deprotonated carbonates, carbonate-containing precipitation material) by methods of the invention that originated from the source of CO₂ (i.e., multi-component gaseous stream) may vary. In some instances, the amount of carbon and oxygen (as determined by using protocols such as isotopic analysis, e.g., ¹³C isotopic analysis, ¹⁸O isotopic analysis) that originated from the source of CO₂ ranges from 1% to 15%, such as 5 to 15%, and including 5 to 14%, such as 5 to 13%, such as 6 to 14%, such as 6 to 12%, and including 7 to 12%. In other instances, a substantial amount of the carbon and oxygen present in products produced by methods of the invention may be carbon and oxygen that originated from the CO₂ in the multi-component gaseous stream. By substantial amount is meant that 10 to 100%, such as 50 to 100% and including 90 to 100% of the carbon and oxygen present in products produced by methods of the invention is from the CO₂ in the multi-component gaseous stream. In some instances, the amount of carbon and oxygen present in the product derived from the multi-component gaseous stream is 50% or more, 60% or more, 70% or more, 80% or more, 90% or more, 95% or more, 99% or more, including 100%.

In some embodiments, methods of the invention include determining the amount of carbon and oxygen present in products produced (e.g., protonated carbonates, deprotonated carbonates and carbonate-containing precipitation material) that originated from the CO₂-containing multi-component gaseous stream. In certain embodiments, methods include verifying that carbon and oxygen present in the product produced by methods of the invention originates from the multi-component gaseous stream, such as by comparing relative isotopic ratio values (δ¹³C or δ¹⁸O) from carbon dioxide present in the multi-component gaseous stream and the carbon and oxygen isotopic values in the products produced. Verifying that a particular product produced contains carbon and oxygen from CO₂ that is from a particular source, e.g., a multi-component gaseous stream, may also include comparing the isotopic value with a standard value, a raw material value or the like.

Many elements have stable isotopes and these isotopes may be present in the multi-component gaseous stream in distinctive amounts. An example is carbon, which will be used to illustrate one example of a multi-component gaseous stream and products produced by methods of the invention described herein. However, it will be appreciated that these methods are also applicable to other elements with stable isotopes if their ratios can be measured in a similar fashion to carbon; such elements may include oxygen, nitrogen, sulfur, and boron. Methods for characterizing a composition by measuring its relative isotope composition (e.g., δ¹³C) and determining that a composition originated from a particular source, e.g., carbon dioxide present in a multi-component gaseous stream, is described in U.S. Pat. No. 7,744,761 filed 27 Jun. 2008 and granted 29 Jun. 2010, and U.S. patent application Ser. No. 12/571,400 filed 30 Sep. 2009; the disclosures of which are herein incorporated by reference.

The relative carbon isotope (δ¹³C) value with units of % (per mil) is a measure of the ratio of the concentration of two stable isotopes of carbon present in the multi-component gaseous stream or product produced, namely ¹²C and ¹³C, relative to a standard of fossilized belemnite (PDB standard).

δ¹³C %=[(13C/¹²Cₛₐₘₚₗₑ−¹³C/¹²C_{PDB Standard})/(¹³C/¹²C_{PDB Standard})]×1000

In some embodiments, the δ¹³C value of carbon present in carbon dioxide from a multi-component gaseous stream of interest may vary, ranging between −1% to −50%. In some embodiments, the δ¹³C value for the carbon present in carbon dioxide from a multi-component gaseous stream may be between −1% and −50%, between −5% and −40%, between −5% and −35%, between −7% and −40%, between −7% and −35%, between −9% and −40%, or between −9% and −35%0. In some embodiments, the δ¹³C value for carbon present in carbon dioxide from a multi-component gaseous stream may be less than (i.e., more negative than) −3%, −5%, −6%, −7%, −8%, −9%, −10%, −11%, −12%, −13%, −14%, −15%, −16%, −17%, −18%, −19%, −20%, −21%, −22%, −23%, −24%, −25%, −26%, −27%, −28%, −29%, −30%, −31%, −32%, −33%, −34%, −35%, −36%, −37%, −38%, −39%, −40%, −41%, −42%, −43%, −44%, or −45%, wherein the more negative the δ¹³C value, the more rich the carbon dioxide from a multi-component gaseous stream is in ¹²C. Any suitable method may be used for measuring the δ¹³C value, methods including, but not limited to, mass spectrometry or off-axis integrated-cavity output spectroscopy (off-axis ICOS).

In some embodiments, the δ¹⁸O value of oxygen present in carbon dioxide from a multi-component gaseous stream of interest may vary, ranging between −1% and −50%, between −5% and −40%, between −5% and −35%, between −7% and −40%, between −7% and −35%, between −9% and −40%, between −9% and −35%, between −10%0 and −25%, between −14% and −25%, including between −14% and −21%. In some embodiments, the δ¹⁸O value of the subterranean brine may be less than (i.e., more negative than) −3%, −5%, −6%, −7%, −8%, −9%, −10%, −11%, −12%, −13%, −14%, −15%, −16%, −17%, −18%, −19%, −20%, or −21% wherein the more negative the δ¹⁸O value, the more rich the carbon dioxide from a multi-component gaseous stream is in ¹⁶O. Any suitable method may be used for measuring the δ¹⁸O value, methods including, but not limited to, mass spectrometry or off-axis integrated-cavity output spectroscopy (off-axis ICOS).

One difference between the carbon and oxygen isotopes is in their mass. Any mass-discerning technique sensitive enough to measure the amounts of carbon can be used to find ratios of the ¹³C to ¹²C isotope concentrations. Mass spectrometry is commonly used to find δ¹³C values. Commercially available are bench-top off-axis integrated-cavity output spectroscopy (off-axis ICOS) instruments that are able to determine δ¹³C values as well. These values are obtained by the differences in the energies in the carbon-oxygen double bonds made by the ¹²C and ¹³C isotopes in carbon dioxide. The δ¹³C value of a product from methods of the invention serves as a fingerprint for a CO₂ gas source as this value will vary from source to source.

A further feature of some embodiments of the invention includes comparing the δ¹³C value for products produced by methods of the invention with another δ¹³C value; this other δ¹³C value may be a standard value, a value for a possible raw material (e.g., natural gas), or any other value that gives useful information for the comparison. In some embodiments, the δ¹³C value for products produced by methods of the invention is compared to a fixed value or range of values, such as a value between −1% and −50%, between −5% and −40%, between −5% and −35%, between −7% and −40%, between −7% and −35%, between −9% and −40%, or between −9% and −35%, or a comparison to a value that is −3%, −5%, −6%, −7%, −8%, −9%, −10%, −11%, −12%, −13%, −14%, −15%, −16%, −17%, −18%, −19%, −20%, −21%, −22%, −23%, −24%, −25%, −26%, −27%, −28%, −29%, −30%, −31%, −32%, −33%, −34%, −35%, −36%, −37%, −38%, −39%, −40%, −41%, −42%, −43%, −44%, or −45%, In some embodiments, a value less than a fixed value is indicative that some or substantially all of the carbon in the product is of fossil fuel origin, e.g. a value less than any of the values given herein, such as a value less than −7%, or a value less than −10%0, or a value less than %, or a value less than −20%0, or a value less than −25%, or a value less than −30%0, or a value less than −35%, a value less than −40%0.

In some embodiments, the δ¹³C value for the composition is compared to a value for a possible raw material. For example, the δ¹³C value for the composition may be compared to a δ¹³C value, or a range of δ¹³C values, for a fossil fuel, such as a natural gas, an oil, or coal. This can be particularly useful in verifying that the composition contains carbon dioxide from burning of the fossil fuel. As an example only, if the δ¹³C value for a natural gas is −34% and the δ¹³C value for a product produced by methods of the invention is equal to or within a certain range of −34% (which can be any suitable range, depending on measurement conditions, variations in the natural gas, etc., e.g., +1%, or +2%, or +3%, or +4%, +5%), this may be considered verification, in whole or in part, that the carbon in the product originated in the natural gas. In the above example, if the acceptable range is +3% and the product has a δ¹³C value of −32% then the δ¹³C value would be considered consistent with an origin for the carbon in the product from that particular natural gas. Other factors may be considered in the verification, as appropriate.

### B. Systems

Aspects of the invention also include systems, e.g., processing plants or factories for practicing methods as described above. Systems of the invention may have any configuration which enables practice of the particular production method of interest. In one aspect, there are provided system that include a natural gas-burning source configured to produce power and flue gas wherein the natural gas-burning source generates the flue gas comprising 1 ton or less of carbon dioxide per megawatt hour; a source of one or more aqueous compositions; and one or more reactors operably connected to the sources and configured for contacting the flue gas and the one or more aqueous compositions to produce a protonated carbonate

As described herein, separating carbon dioxide gas from a multi-component gaseous stream by methods of the invention consumes an amount of energy which is less than the amount of energy generated during the production of the multi-component gaseous stream. As such, systems of the invention are configured such that separating carbon dioxide from the multi-component gaseous stream, in some embodiments, consumes less than 100% of the energy generated by the source of the multi-component gaseous stream, such as 90% or less, such as 80% or less, such as 70% or less, such as 60% or less, such as 50% or less, such as 40% or less, such as 30% or less, such as 20% or less, such as 10% or less, including 5% or less of the energy generated from the multi-component gaseous stream. As such, the energy generated by the source of the multi-component gaseous stream may in some embodiments, be 1.5-fold or more than the amount of the energy required to separate carbon dioxide gas from the multi-component gaseous stream, such as 2-fold or more, such as 2.5-fold or more, such as 3-fold or more, such as 4-fold or more, such as 5-fold or more, such as 6-fold or more, such as 7-fold or more, such as 8-fold or more, such as 9-fold or more, including 10-fold or more than the amount of energy required to separate carbon dioxide gas from the multi-component gaseous stream.

In some embodiments, systems of the invention include a source of a multi-component gaseous stream, such as a natural-gas burning source which provides flue gas or carbon dioxide. The source of multi-component gaseous stream may be any convenient gaseous stream. The source of the multi-component gaseous stream is, in certain embodiments, a waste feed from a power plant. By waste feed is meant a stream of gas (or analogous stream) that is produced as a byproduct of an active process of the power plant. The gaseous stream may be substantially pure CO₂ or a multi-component gaseous stream that includes CO₂ and one or more additional gases. The nature of the power plant may vary in these embodiments, where power plants can include any industrial plant for generating power that produces a multi-component gaseous stream containing carbon dioxide as a byproduct of fuel combustion. In some embodiments, the source of the multi-component gaseous stream is a power plant that combusts coal, oil, crude petroleum, petroleum coke among other sources of fuel. In other embodiments, the source of the multi-component gaseous stream is a power plant that combusts fuels derived from tar sands, such as for example, oil shale, coal liquids, coal gasification and biofuels that are made available via syngas. In certain embodiments, the source of the multi-component gaseous stream, such as flue gas, is a power plant that combusts or burns natural gas. The “natural gas” is as described herein.

Systems of the invention may also include structures such as a pipe, duct, or conduit which direct the source of the multi-component gaseous stream, such as flue gas from the natural-gas burning power plant, to the reactor for contacting the aqueous composition with the multi-component gaseous stream.

In some embodiments, systems of the invention include a source of one or more aqueous compositions. The source of one or more aqueous compositions may vary depending on the particular method of separating carbon dioxide from the multi-component gaseous stream that is to be performed. In some embodiments, the source of one or more aqueous compositions may be any saltwater source, such as a naturally occurring source, e.g., a sea, ocean, lake, swamp, estuary, lagoon, deep brine, alkaline lakes, inland seas, etc., or a man-made source.

Another source of an aqueous composition that may be employed are mineral rich freshwater sources. Mineral rich freshwater sources of interest may be naturally occurring, such as hard waters or lakes or inland seas, for example alkaline lakes or inland seas (such as Lake Van in Turkey) which may provide a source of alkalinity for removal of protons and/or pH shift and/or a source of minerals. Mineral rich freshwater sources of interest may also be man-made, e.g., by producing a mineral rich water from a soft water. For example, a mineral poor (soft) water may be contacted with a source of desired ions, such as a calcium and/or magnesium ion source, to produce a mineral rich water that is suitable for use in methods of the invention.

Where the aqueous composition is a subterranean brine, systems of the invention may include a source of one or more subterranean brines. The source of one or more subterranean brines may be any convenient source. In some embodiments, the source of subterranean brine is an above-ground storage basin which contains a stored subterranean brine obtained from a subterranean location. The above-ground storage basin may be any convenient container, such as a geological structure (e.g., tailings pond, dried riverbed) or may be a man-made storage basin, e.g., storage tank. In some embodiments, subterranean brines may also be stored in the underground location where the subterranean brine is obtained, until needed and as such, the source for one or more subterranean brines may be the subterranean location where the subterranean brine is obtained. For example, in these embodiments, the source for a subterranean brine may be a deep geological alkaline aquifer or an underground well located in the sedimentary basins of a petroleum field, a subterranean metal ore mine, a geothermal field, an oceanic ridge, among other underground locations.

In some embodiments, systems of the invention may also include structures such as a pipe or conduit for conveying the aqueous composition from the source of the aqueous composition to the reactor for contacting the aqueous composition with the multi-component gaseous stream. In some instances, the conveyance structure may include pumps for pumping the aqueous composition into the contacting reactor, such as a turbine-motor pump, rotary lobe pump, hydraulic pump, fluid transfer pump, etc.

In some embodiments, systems of the invention also include one or more reactors configured for contacting the source of the aqueous composition with the source of the multi-component gaseous stream, such as flue gas, to produce a protonated carbonate. The contacting reactor may include any means for contacting, including, but not limited to, devices for contacting the aqueous composition with the multi-component gaseous stream, such as for example gas bubblers, contact infusers, fluidic Venturi reactors, spargers, components for mechanical agitation, stirrers, components for recirculation of the multi-component gaseous stream through the contacting reactor, gas filters, sprays, trays, or packed column reactors, and the like, as may be convenient. In some embodiments, precipitation of the carbonate-containing precipitation material may occur in the contacting reactor. As such, the contacting reactor may also include components for controlling precipitation conditions, such as temperature and pressure regulators and components for mechanical agitation and/or physical stirring mechanisms. The contacting reactor may also include filters and trays to allow for settling of the carbonate-containing precipitation material in the contacting reactor.

In some embodiments, the systems include a source of proton-removing agent. The source for proton-removing agent can be any source that provides the proton-removing agent described herein. For example, in some embodiments, systems may include an electrochemical system configured to provide proton-removing agent to remove protons from the protonated carbonate composition to produce a deprotonated carbonate. In some embodiments, electrochemical systems of the invention are low-voltage electrochemical systems. Low voltage electrochemical systems of the invention employ electrochemical protocols operating at an average voltage of 2, 1.9, 1.8, 1.7, or 1.6 V or less, such as 1.5, 1.4, 1.3, 1.2, 1.1 V or less, such as 1 V or less, such as 0.9 V or less, 0.8 V or less, 0.7 V or less, 0.6 V or less, 0.5 V or less, 0.4 V or less, 0.3 V or less, 0.2 V or less, or 0.1 V or less. In some embodiments, electrochemical systems of the invention employ low-voltage electrochemical protocols and do not generate chlorine gas. In other embodiments, low-voltage electrochemical systems that do not generate oxygen gas may be employed. In some embodiments low-voltage electrochemical systems that produce no gas at the anode may be employed. Systems of the invention may also include low-voltage electrochemical systems that generate hydrogen gas at the cathode and transport it to the anode where the hydrogen gas is converted to protons. In other embodiments, electrochemical systems that do not generate hydrogen gas may also be employed. In some embodiments, electrochemical systems include systems that use an oxygen depolarized cathode and a gas diffusion anode where hydrogen gas is oxidized to form hydrogen ions at the anode. In such embodiments, the hydrogen gas may be obtained from a natural-gas burning process.

Electrochemical systems of the invention may be in some instances, configured to remove protons without the production of hydroxide (e.g., if proton production from carbon dioxide dissolution matches or exceeds proton removal by an electrochemical process). In other instances, electrochemical systems are configured to produce hydroxide.

In certain embodiments, the present invention provides a low energy electrochemical system for removing protons from the protonated carbonate composition having an ion exchange membrane in an electrochemical cell. Some examples of the electrochemical systems are as illustrated in FIGS. 1-3 (including FIGS. 2A and 3A) and described herein. The system in some embodiments includes an anionic or cationic exchange membrane positioned between a first electrolyte and a second electrolyte, the first electrolyte (anode electrolyte) contacting an anode and the second electrolyte (cathode electrolyte) contacting a cathode. In some embodiments, electrolytes may be a saltwater such as sodium chloride, seawater, brackish water or freshwater. On applying a low voltage across the anode and cathode, hydroxide forms at the cathode and protons form at the anode without a gas, e.g., chlorine or oxygen, forming at the anode. Depending on the electrolytes used, a hydroxide solution, e.g., sodium hydroxide, forms in the second electrolyte in contact with the cathode and an acid, e.g., hydrochloric acid forms in the first electrolyte in contact with the anode.

In certain embodiments, electrochemical systems of the invention include an electrochemical cell having an anion exchange membrane separating a first electrolyte from a third electrolyte; a cation exchange membrane separating the second electrolyte from a first electrolyte; an anode in contact with the first electrolyte; and a cathode in contact with a second electrolyte. On applying a low voltage across the anode and cathode, hydroxide forms at the cathode without forming a gas, e.g., chlorine or oxygen forming at the anode. Depending on the electrolyte used, a hydroxide solution, e.g., sodium hydroxide, forms in the second electrolyte in contact with the cathode, and an acid, e.g., hydrochloric acid forms in the first electrolyte in contact with the anode.

In certain embodiments, electrochemical systems of the invention may be configured for migrating ions across an ion exchange membrane in an electrochemical cell, wherein the ion exchange membrane is disposed between a first electrolyte and a second electrolyte, the first electrolyte contacting an anode and the second electrolyte contacting a cathode, by applying a voltage across the anode and cathode to form hydroxide ions at the cathode without forming a gas, e.g., chlorine or oxygen at the anode. Depending on the electrolyte used, a hydroxide solution, e.g., sodium hydroxide forms in the second electrolyte in contact with the cathode and an acid, e.g., hydrochloric acid forms in the first electrolyte in contact with the anode.

In another embodiment, electrochemical systems of the invention may include an anode and cathode, where the anode is in contact with a first electrolyte and is in contact with an anion exchange membrane; the cathode is in contact with a second electrolyte and is in contact with a cation exchange membrane; and a third electrolyte disposed between the anion exchange membrane and the cation exchange membrane and is configured to form hydroxide ions at the cathode without forming a gas e.g., chlorine or oxygen at the anode. In embodiments of the invention, hydroxide is produced at the cathode in contact the second electrolyte without a gas e.g., chlorine or oxygen at the anode. Depending on the electrolyte used, a hydroxide solution, e.g. sodium hydroxide, forms in the second electrolyte in contact with the cathode, and an acid, e.g., hydrochloric acid forms in the first electrolyte in contact with the anode.

Electrochemical systems configured for removing protons from the protonated carbonate composition may include, but are not limited, those described in U.S. patent application Ser. No. 12/344,019, filed 24 Dec. 2008; U.S. patent application Ser. No. 12/375,632, filed 23 Dec. 2008, International Patent Application No. PCT/US08/088,242, filed 23 Dec. 2008; International Patent Application No. PCT/US09/32301, filed 28 Jan. 2009; International Patent Application No. PCT/US09/48511, filed 24 Jun. 2009; U.S. patent application Ser. No. 12/541,055 filed 13 Aug. 2009; and U.S. patent application Ser. No. 12/617,005, filed 12 Nov. 2009, the disclosures of which are incorporated herein by reference in their entirety. Also of interest are the electrochemical methods described in published United States Application Publication Nos. 20060185985 and 20080248350, as well as published PCT Application Publication No. WO 2008/018928; the disclosures of which are hereby incorporated by reference.

The systems provided herein include a hydrogen gas supply or delivery system operably connected to the anode chamber or the anode electrolyte. The hydrogen gas delivery system is configured to provide hydrogen gas to the anode. In some embodiments, the hydrogen gas delivery system is configured to deliver gas to the anode where oxidation of the gas is catalyzed to protons and electrons. In some embodiments, the hydrogen gas is oxidized to protons and electrons; un-reacted hydrogen gas in the system is recovered; and re-circulated to the anode. The hydrogen gas may be supplied to the anode using any means for directing the hydrogen gas from the external source to the anode. Such means for directing the hydrogen gas from the external source to the anode or the hydrogen gas delivery system are well known in the art and include, but not limited to, pipe, duct, conduit, and the like. In some embodiments, the system or the hydrogen gas delivery system includes a duct that directs the hydrogen gas from the external source to the anode. It is to be understood that the hydrogen gas may be directed to the anode from the bottom of the cell, top of the cell or sideways. In some embodiments, the hydrogen gas may be directed to the anode through multiple entry ports.

The systems provided herein further include an oxygen gas supply or delivery system operably connected to the cathode chamber or the cathode electrolyte. The oxygen gas delivery system is configured to provide oxygen gas to the gas-diffusion cathode. In some embodiments, the oxygen gas delivery system is configured to deliver gas to the gas-diffusion cathode where reduction of the gas is catalyzed to hydroxide ions. In some embodiments, the oxygen gas is reduced to hydroxide ions; un-reacted oxygen gas in the system is recovered; and re-circulated to the cathode. The oxygen gas may be supplied to the cathode using any means for directing the oxygen gas from the external source to the cathode. Such means for directing the oxygen gas from the external source to the cathode or the oxygen gas delivery system are well known in the art and include, but not limited to, pipe, duct, conduit, and the like. In some embodiments, the system or the oxygen gas delivery system includes a duct that directs the oxygen gas from the external source to the cathode. It is to be understood that the oxygen gas may be directed to the cathode from the bottom of the cell, top of the cell or sideways. In some embodiments, the oxygen gas is directed to the back side of the cathode where the oxygen gas is not in direct contact with the catholyte. In some embodiments, the oxygen gas may be directed to the cathode through multiple entry ports. The source of oxygen that provides oxygen gas to the gas-diffusion cathode, in the methods and systems provided herein, includes any source of oxygen known in the art. Such sources include, without limitation, ambient air, commercial grade oxygen gas from cylinders, oxygen gas obtained by fractional distillation of liquefied air, oxygen gas obtained by passing air through a bed of zeolites, oxygen gas obtained from electrolysis of water, oxygen obtained by forcing air through ceramic membranes based on zirconium dioxides by either high pressure or electric current, chemical oxygen generators, oxygen gas as a liquid in insulated tankers, or combination thereof. In some embodiments, the source of oxygen may also provide carbon dioxide gas. In some embodiments, the oxygen from the source of oxygen gas may be purified before being administered to the cathode chamber. In some embodiments, the oxygen from the source of oxygen gas is used as is in the cathode chamber.

In some embodiments, the systems provided herein include a contactor operably connected to the cathode electrolyte and configured to contact the multi-component gaseous stream, such as flue gas from the natural-gas burning power plant, to the cathode electrolyte. The contact system or the contactor includes any means for contacting the multi-component gaseous stream, such as flue gas from the natural-gas burning power plant, to the cathode electrolyte inside a cathode chamber or outside the cathode chamber. Such means or the contactor configured to contact multi-component gaseous stream, such as flue gas from the natural-gas burning power plant, with the cathode electrolyte, are well known in the art and include, but not limited to, injection, pipe, duct, conduit, and the like. In some embodiments, the system includes a duct that directs the multi-component gaseous stream, such as flue gas from the natural-gas burning power plant, inside a cathode chamber. It is to be understood that when the multi-component gaseous stream, such as flue gas from the natural-gas burning power plant, is contacted with the cathode electrolyte inside the cathode chamber, it may be injected to the cathode electrolyte from the bottom of the cell, top of the cell, from the side inlet in the cell, and/or from all entry ports depending on the amount of carbon dioxide desired in the cathode chamber. It is to be understood that the amount of carbon dioxide inside the cathode chamber may be dependent on the flow rate of the solution, desired pH of the cathode electrolyte, and/or size of the cell. Such optimization of the amount of the multi-component gaseous stream, such as flue gas from the natural-gas burning power plant, is well within the scope of the invention.

In some embodiments, the contactor is a gas/liquid contactor. In such embodiments, the multi-component gaseous stream, such as flue gas from the natural-gas burning power plant, is contacted with a gas/liquid contactor containing the aqueous composition and/or the cathode electrolyte. The gas/liquid contactor is then operably connected to the cathode chamber and is configured to deliver the protonated or partially protonated solution to the cathode electrolyte.

In some embodiments, the cathode chamber includes a partition that helps facilitate delivery of the carbon dioxide gas or the flue gas and/or solution of carbon dioxide in the cathode chamber. In some embodiments, the partition may help prevent mixing of the carbon dioxide gas with the oxygen gas and/or mixing of the carbon dioxide gas in the cathode chamber with the hydrogen gas in the anode chamber. In some embodiments, the partition results in the catholyte with a gaseous form of carbon dioxide as well as dissolved form of carbon dioxide. In some embodiments, the systems provided herein include a partition that partitions the cathode electrolyte into a first cathode electrolyte portion and a second cathode electrolyte portion, where the second cathode electrolyte portion that includes dissolved carbon dioxide contacts the cathode; and where the first cathode electrolyte portion that includes dissolved carbon dioxide and gaseous carbon dioxide, contacts the second cathode electrolyte portion under the partition. In the system, the partition is positioned in the cathode electrolyte such that a gas, e.g., carbon dioxide in the first cathode electrolyte portion is isolated from cathode electrolyte in the second cathode electrolyte portion. Thus, the partition may serve as a means to prevent mixing of the gases on the cathode and/or the gases and or vapor from the anode. Such partition is described in U.S. Publication No. 2010/0084280, filed Nov. 12, 2009, which is incorporated herein by reference in its entirety in the present disclosure.

In some embodiments, the solution charged with the partially or fully dissolved CO₂ is made by sparging or diffusing the multi-component gaseous stream through a solution to make a CO₂ charged water. In some embodiments, the solution charged with CO₂ includes a proton removing agent. In some embodiments, the CO₂ or flue gas is bubbled or sparged through a solution containing a proton removing agent, such as sodium or potassium hydroxide, in an absorber. By way of example only, the absorber is an example of a gas/liquid contactor configured to contact the carbon dioxide or flue gas with the cathode electrolyte. In some embodiments, the absorber may include a bubble chamber where the flue gas is bubbled through the solution containing the proton removing agent. In some embodiments, the absorber may include a spray tower where the solution containing the proton removing agent is sprayed or circulated through the flue gas. In some embodiments, the absorber may include a pack bed to increase the surface area of contact between the flue gas and the solution containing the proton removing agent. In some embodiments, a typical absorber fluid temperature is 32-37° C. The absorber for absorbing CO₂ in the solution is described in U.S. application Ser. No. 12/721,549, filed on Mar. 10, 2010, which is incorporated herein by reference in its entirety in the present disclosure.

In some embodiments, the alkali produced in the cathode electrolyte may be delivered to the gas/liquid contactor where the carbon dioxide gas comes into contact with the alkali. The carbon dioxide gas after coming into contact with the alkali may result in the formation of carbonic acid, bicarbonate ions, carbonate ions, or combination thereof. The dissolved form of carbon dioxide may be then delivered back to the cathode chamber where the alkali may convert the bicarbonate into the carbonate. The carbonate/bicarbonate mix may be then used as is for commercial purposes or is treated with alkaline earth metal ions to form carbonate-containing precipitation material.

The system in some embodiments includes a cathode electrolyte circulating system adapted for withdrawing and circulating cathode electrolyte in the system. In some embodiments, the cathode electrolyte circulating system includes a gas/liquid contactor outside the cathode chamber that is adapted for contacting the multi-component gaseous stream, such as flue gas from the natural-gas burning power plant, with the circulating cathode electrolyte, and for re-circulating the electrolyte in the system. As the pH of the cathode electrolyte may be adjusted by withdrawing and/or circulating cathode electrolyte/carbon dioxide from the system, the pH of the cathode electrolyte compartment can be regulated by regulating an amount of cathode electrolyte removed from the system, passed through the gas/liquid contactor, and/or re-circulated back into the cathode chamber.

In some embodiments, the systems provided herein are integrated with the natural-gas burning power plant such that the carbon dioxide and/or the hydrogen gas produced from the natural gas is delivered to the systems of the invention. In some embodiments, the natural-gas burning power plants are retrofitted with the systems of the invention. In some embodiments, the carbon dioxide and/or the hydrogen gas produced from the natural gas burning is delivered to the systems of the invention within 1-5 mile radius of the plant. In some embodiments, the carbon dioxide and/or the hydrogen gas produced from the natural gas burning is delivered to the systems of the invention through the gas pipes, conduits or ducts. These pipes, conduits or ducts may be above the ground or below the ground.

In some embodiments, systems of the invention may also include one or more detectors configured for monitoring the makeup of the protonated carbonate composition, deprotonated carbonate composition, carbonate-containing precipitation material or depleted aqueous composition. Monitoring may include, but is not limited to determining the chemical makeup (e.g., metal composition, salt composition, ionic composition, organometallic composition, organic composition), pH, physical properties (e.g., boiling point), electrochemical properties, spectroscopic properties, acid-base properties, polydispersities, and partition coefficient. The detectors may be any convenient device configured to determine the composition of a gas, liquid, or solid, or a mixture thereof, and may in some embodiments be an inductively coupled plasma-atomic emission spectrometer (ICP-AES), a mass spectrometer, an X-ray diffractometer, UV-vis spectrometer, pH meter, gas chromatograph, infrared spectrometer, etc. In some embodiments, the detector may be configured to monitor conditions of the system such as pressure, temperature, temperature, pH, precipitation material particle size, metal-ion concentration, conductivity, alkalinity, pCO₂, etc.

In some embodiments, the detector may also include a computer interface which is configured to provide a user with the determined composition of the protonated carbonate composition, deprotonated carbonate composition, carbonate-containing precipitation material or depleted aqueous composition. For example, the detector may determine the composition and the computer interface may provide a summary of the composition.

In some embodiments, the detector may be a monitoring device such that it can collect real-time data (e.g., carbonic acid concentration, bicarbonate concentration, carbonate concentration, etc.). In other embodiments, the detector may be one or more detectors configured to collect data at regular intervals, e.g., determining the composition every 1 minute, every 5 minutes, every 10 minutes, every 30 minutes, every 60 minutes, every 100 minutes, every 200 minutes, every 500 minutes, or some other interval.

Systems of the invention may also include one or more processing stations configured to process the protonated carbonate composition, deprotonated carbonate composition, carbonate-containing precipitation material or depleted aqueous composition, as desired. In some embodiments, the one or more processing stations may include mixing reactors, compressors, compound concentrators or temperature regulators. Systems configured for processing the protonated carbonate composition, deprotonated carbonate composition, carbonate-containing precipitation material or depleted aqueous composition may include, but are not limited, those described in U.S. patent application Ser. No. 12/344,019, filed 24 Dec. 2008; U.S. patent application Ser. No. 12/375,632, filed 23 Dec. 2008; U.S. Provisional Patent Application No. 61/264,564 filed 25 Nov. 2009 and U.S. Provisional Patent Application No. 61/305,075 filed 16 Feb. 2010; the disclosures of which are herein incorporated by reference.

In some embodiments, systems of the invention also include systems for sequestering the produced deprotonated carbonate composition (e.g., conveying to a sequestration location) and a carbonate-containing precipitation material production station for producing a carbonate-containing precipitation material from the deprotonated carbonate composition.

In some embodiments, systems of the invention also include a mass control station, configured to regulate the amount of the deprotonated carbonate composition sequestered and the amount of the deprotonated carbonate composition conveyed to a carbonate-containing precipitation material production station. For instance, the amount of deprotonated carbonate composition which is sequestered may be regulated by the mass control station to be 1% or greater of the produced deprotonated carbonate composition, such as 5% or greater, such as 10% or greater, such as 25% or greater, such as 50% or greater, such as 75% or greater, such as 90% or greater, such as 95% or greater, and including 99% or greater of the produced deprotonated carbonate composition. In these instances, the mass control station may convey the remainder of the deprotonated carbonate composition to a carbonate-containing precipitation material production station or alternatively, for some other function, as desired, e.g., acid-neutralization protocols. The mass control station may regulate the amount of the deprotonated carbonate composition sequestered or conveyed to a carbonate-containing precipitation material production station by any convenient protocol. In embodiments of the invention, the mass control station can adjust the output of the deprotonated carbonate composition from the deprotonated carbonate composition production reactor at any time. By adjust the output is meant that the intended destination (e.g., sequestration location, carbonate-containing precipitation material production plant, etc.) and amount of deprotonated carbonate composition conveyed from the deprotonated carbonate composition production reactor can be changed or modified at any time. The mass control station may employ any convenient protocol to regulate the output of deprotonated carbonate composition from the deprotonated carbonate composition production reactor. For example, the mass control station may employ a set of valves or a multi-valve system which is manually, mechanically or digitally controlled, or may employ any other convenient flow regulation protocol. In some instances, the mass control station may include a computer interface, (where the flow regulator is computer-assisted or controlled entirely by a computer) configured to provide a user with input and output parameters to control the output flow of the deprotonated carbonate composition to the sequestration location or to the carbonate-containing precipitation material production station.

In some embodiments, the deprotonated carbonate composition is sequestered. As such, systems of the invention may include a sequestration location. Sequestration locations of the invention may be any convenient reservoir for storing the deprotonated carbonate composition. For example, the sequestration location may be a tailings pond or a man-made above or underground storage facility. In some embodiments, the sequestration location may be a subterranean formation, such as for example, a deep geological aquifer or an underground well located in the sedimentary basins of a petroleum field, a subterranean metal ore, a geothermal field, or an oceanic ridge, among other underground locations. In some embodiments, the subterranean formation is located 100 m or deeper below ground level, such as 200 m or deeper below ground level, such as 300 m or deeper below ground level, such as 400 m or deeper below ground level, such as 500 m or deeper below ground level, such as 600 m or deeper below ground level, such as 700 m or deeper below ground level, such as 800 m or deeper below ground level, such as 900 m or deeper below ground level, such as 1000 m or deeper below ground level, such as 1500 m or deeper ground level, such as 2000 m or deeper below ground level, such as 2500 m or deeper below ground level, and including 3000 m or deeper below ground level.

In some embodiments, systems of the invention may also include systems for conveying the deprotonated carbonate composition to the sequestration location. Systems for producing the deprotonated carbonate composition may be located within 1.5 kilometers (km) or less from systems for conveying the bicarbonate composition to a sequestration location. In some embodiments, systems for producing a deprotonated carbonate composition may be located within 4500 km or less from systems for conveying the deprotonated carbonate composition to a sequestration location, such as 3000 km or less, such as 1000 km or less, such as 500 km or less, such as 250 km or less, such as 200 km or less, such 100 km or less, such as 50 km or less, such as 10 km or less from systems for conveying the deprotonated carbonate composition to a sequestration location. In certain instances, systems for producing a deprotonated carbonate composition may be co-located with systems for conveying the deprotonated carbonate composition to a sequestration location. Systems for electrochemically removing protons from the protonated carbonate composition to produce the deprotonated carbonate composition and systems for conveying the deprotonated carbonate composition to a sequestration location may be configured to allow for synchronizing their activities. In certain instances, the activity of one system may not be matched to the activity of the other. For example, systems for conveying the deprotonated carbonate composition to the sequestration location may need to reduce or stop its acceptance of the deprotonated carbonate composition but the system for electrochemically removing protons from the protonated carbonate composition to produce the deprotonated carbonate composition may need to keep operating. Conversely, situations may arise where the system for producing the deprotonated carbonate composition reduces or ceases operation and systems for conveying the deprotonated carbonate composition to the sequestration location do not. To address situations where either the electrochemical system for producing the deprotonated carbonate composition or systems for conveying the deprotonated carbonate composition to the sequestration location may need to reduce or stop its activities, design features that provide for continued operation of one of the systems while the other reduces or ceases operation may be employed. For example, systems of the invention may include in certain embodiments, a deprotonated carbonate composition storage facility present between systems for producing the deprotonated carbonate composition and the systems for conveying the deprotonated carbonate composition to a sequestration location. In another example, where systems for conveying the deprotonated carbonate composition to the sequestration location need to reduce or stop its activities, the mass control station may increase the amount of the deprotonated carbonate composition conveyed to the carbonate-containing precipitation material production station.

Systems of the invention may also include one or more detectors configured for monitoring the energy consumption of the system. Determining the energy consumption of separating carbon dioxide from the multi-component gaseous stream may include, but is not limited to, quantifying the amount of energy consumed by contacting protocols, electrochemically removing protons, heating or cooling protocols, gas pressurization protocols, temperature adjustment protocols, pumping protocols, mixing protocols, precipitation protocols, composition analysis protocols, mass transfer protocols and refinement protocols. The detectors for determining the energy consumption by any part of systems of the invention may be any convenient electric meter configured to monitor energy consumption and may include, but are limited to electromechanical induction meters, electronic electricity meters, voltmeters, current transformers, DC meters, AC megawatt hour meters, among other protocols for quantifying electricity consumption.

In some embodiments, systems of the invention may also include an energy control station having a computer interface which is configured to provide a user with the collected data from energy monitoring detectors. For example, a detector may determine the energy consumption by the electrochemical system and the computer interface may provide a summary of the amount of energy consumed by the electrochemical system over time. In some embodiments, the summary may be stored as a computer readable data file or may be printed out as a user readable document. In some embodiments, the energy control station may monitor the energy consumption of the system, such that the energy control station will collect and analyze real-time data (e.g., energy usage from electrochemical system, energy from precipitation reactor etc.) about the energy consumed by the system. In other embodiments, the energy control station may be configured to collect and analyze energy consumption by the system at regular intervals, e.g., determining energy consumption every 1 minute, every 5 minutes, every 10 minutes, every 30 minutes, every 60 minutes, every 100 minutes, every 200 minutes, every 500 minutes, or some other interval.

In some embodiments, the energy control station may also include an energy regulator, configured to adjust the amount of energy consumed by one or more parts of the system. For instance, the amount of energy which is employed by the system may be adjusted when the ratio of the amount of energy generated by the power plant with respect to the amount of carbon dioxide produced reaches or exceeds a predetermined threshold, as described above. In embodiments of the invention, the energy regulator can adjust the energy consumption by any part of the system at any time. By adjust the energy consumption is meant that the amount of energy consumed by a particular part of the system can be increased or decreased at any time. The energy regulator may employ any convenient protocol to adjust the energy consumption. For example, the energy regulator may employ an electric current control system which is digitally controlled. In some instances, the energy regulator may include a computer interface configured to provide a user with parameters for the system and energy consumption data collected by monitoring detectors. The computer interface may be configured to allow the user to control the energy consumption by a particular component of the system.

In some embodiments, the energy regulator may be employed to adjust the applied voltage by the electrochemical system so that the electrochemical system operates at different voltages during different energy cost periods. For example, as the price of electricity may be higher during the daytime than during the night, the energy regulator may adjust the electrochemical system to operate at a voltage of 1.0 V or less, such as 0.9 V or less, such as 0.8 V or less, such as 0.7 V or less, such as 0.6 V or less, such as 0.5 V or less, such as 0.4 V or less, such as 0.3 V or less, such as 0.2 V or less, such as 0.1 V or less during peak energy cost periods (e.g., during the daytime), whereas the energy regulator may adjust the electrochemical system to operate at a voltage of 1.0 V or more, such as 1.1 V or more, such as 1.2 V or more, such as 1.3 V or more, such as 1.4 V or more, such as 1.5 V or more, including 2.0 V or more only during low energy cost periods (e.g., during the night).

In other embodiments, the energy regulator may adjust energy consumption by the system to employ a renewable energy protocol to provide a portion or all of the energy to systems of the invention. As such, the system may be configured such that 10% or more of the required energy by systems of the invention is provided by a renewable energy protocol, such as 20% or more, such as 25% or more, such as 30% or more, such as 40% or more, such as 50% or more, such as 60% or more, such as 70% or more, such as 75% or more, such as 80% or more, such as 90% or more, such as 95% or more and including 95% or more of the required energy by systems of the invention may be provided by a renewable energy protocol. Renewable energy systems may be any convenient renewable energy system, such as solar power plants, gas compression power plants, light-harvesting arrays, wind-harvesting power plants, windmill arrays, or any combination thereof.

Systems of the invention may also include one or more pumping stations for conveying the deprotonated carbonate composition to a sequestration location. The pumping stations may employ one or more pumps for pumping the deprotonated carbonate composition to the sequestration location, such as for example turbine-motor pumps, rotary lobe pumps, hydraulic pumps, fluid transfer pumps, etc. In some embodiments, the reactor for producing the deprotonated carbonate composition and the pumping station may be integrated into a single station.

In some embodiments, systems of the invention may also include one or more conduits to the sequestration location to convey the deprotonated carbonate composition into the subterranean formation. Conduits of the invention may be any tube, pipeline or other analogous conduit structure configured to convey a gas or liquid from one location to another. As described above, conduits of the invention may vary. In some embodiments the cross-sectional shape of the conduit may be circular, rectangular, oblong, square, etc. Depending on the nature of the deprotonated carbonate composition (e.g., viscosity) and the size of the bore hole, the diameter of the conduit may also vary greatly, ranging from 5 to 100 cm, such as 10 to 90 cm, such as 10 to 90 cm, such as 20 to 80 cm, such as 25 to 75 cm, and including 30 to 50 cm. In certain embodiments, conduits may be configured in order to support high internal pressure from the flow of the deprotonated carbonate composition. In other embodiments, the conduit may be configured to support high external loadings (e.g., external hydrostatic pressures, earth loads, etc.). In some embodiments, conduits for conveying the deprotonated carbonate composition may include a plurality (e.g., 2 to 5) of concentric casings that form multiple layers within the conduit so that in the event of a fracture or break in one casing, leakage of the deprotonated carbonate composition into the outside environment may be prevented or reduced. In some embodiments, the concentric casings may be produced from malleable steal or flexible corrosion-resistant materials such as e.g., fiberglass, Teflon, Kevlar, among others.

Systems of the invention may also include a carbonate-containing precipitation material production station for producing a carbonate-containing precipitation material from the deprotonated carbonate composition. In some embodiments, the carbonate-containing precipitation material production station may include one or more reactors configured for contacting a source of one or more divalent cations with the deprotonated carbonate composition to produce a carbonate-containing precipitation material. Where a portion or all of the deprotonated carbonate composition is bicarbonate, the carbonate-containing precipitation material production station may also include a source of one or more proton-removing agents. The reactor for contacting the source of one or more divalent cations with the deprotonated carbonate may be any convenient mixing apparatus, e.g., conventional industrial mixing vessels having counterflow impellers, turbine impellers, anchor impellers, ribbon impellers, axial flow impellers, radial flow impellers, hydrofoil. The contacting reactor may also include conveyance structures such as pipes, ducts, or conduits which are connected to the source of the one or more divalent cations and where desired, the source of the one or more proton-removing agents. The contacting reactor may also include conveyance structures to the control station which regulates the amount of the deprotonated carbonate composition conveyed to the carbonate-containing precipitation material production station.

In some embodiments, the carbonate-containing precipitation material may be precipitated in the contacting reactor. As such, the contacting reactor may also include components for controlling precipitation conditions, such as temperature and pressure regulators and components for mechanical agitation and/or physical stirring mechanisms. The contacting reactor may also include filters and trays to allow for settling of the carbonate-containing precipitation material in the contacting reactor.

In some embodiments, systems of the invention may also include a liquid-solid separator. As described above, liquid-solid separators of the invention may be any convenient separator, such as a basin for gravitational sedimentation of the precipitation material (e.g., where the liquid is separated by draining or decanting), a filter (e.g., gravity filter, vacuum filtration device, etc.), a centrifuge, or any combination thereof. The liquid-solid separator may be operably connected to the contacting or the precipitation reactor such that the carbonate-containing precipitation material may flow from the processor to the liquid-solid separator. Any of a number of different liquid-solid separators may be used in combination, in any arrangement (e.g., parallel, series, or combinations thereof).

In some embodiments, systems may also include a desalination station. The desalination station may be in fluid communication with the liquid-solid separator such that the liquid product may be conveyed from the liquid-solid separator to the desalination station directly. The systems may include a conveyance (e.g., pipe) where the output depleted brine may be directly pumped into the desalination station or may flow to desalination station by gravity. As described in detail above, desalination stations of the invention may employ any convenient protocol for desalination, and may include, but are not limited to distillers, vapor compressors, filtration devices, electrodialyzers, ion-exchange membranes, nano-filtration membranes, reverse osmosis desalination membranes, multiple effect evaporators or a combination thereof.

In some embodiments, systems may also include a drying station for drying the precipitated carbonate-containing precipitation material produced by the precipitation reactor. Depending on the particular drying protocol of the system, the drying station may include a filtration element, freeze drying structure, spray drying structure. The system may also include a conveyer, e.g., duct, from an industrial plant connected to the dryer so that a gaseous waste stream (i.e., industrial plant flue gas) may be contacted directly with the wet precipitate in the drying stage.

In some embodiments, systems of the invention may include a precipitate processing station, for processing the dried precipitate. The processing station may have grinders, millers, crushers, compressors, blender, etc. in order to obtain desired physical properties. One or more components may be added to the precipitate where the precipitate is used as a building material.

The system further includes outlet conveyers, e.g., conveyer belt, slurry pump, that allow for the removal of precipitate from one or more of the following: the contacting reactor, precipitation reactor, drying station, or from the refining station.

In certain embodiments, the system may further include a station for preparing a building material, such as cement, from the precipitate. This station can be configured to produce a variety of cements, aggregates, or cementitious materials from the precipitate, such as described in detail above.

In some embodiments, the system may further include a system control module for controlling components of the system. In some instances, the system control module includes a graphical interface and one or more input devices (e.g., keyboard, mouse, etc.) such that the user can control various components of the system. For example, the system control module may be configured so that a user may control contacting protocols, electrochemical system protocols, heating or cooling protocols, pressurization protocols, temperature adjustment protocols, pumping protocols, mixing protocols, precipitation protocols, composition analysis protocols, mass transfer protocols and refinement protocols. In addition, the system control module may also be configured to collect data from the energy control station or mass control station to provide the user with parameters and a summary of the collected data.

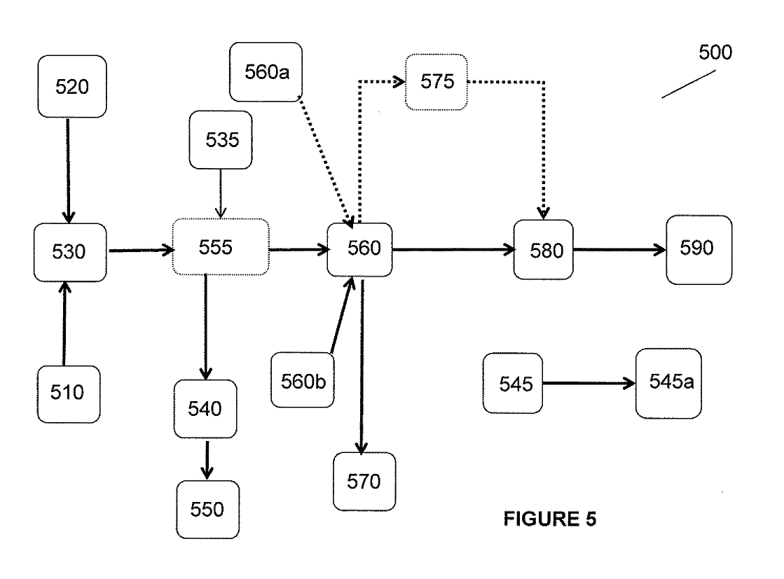

FIG. 5 provides a schematic of a system according to some embodiments of the invention. In FIG. 5, system 500 includes a CO₂-containing multi-component gaseous stream source 520 (e.g., flue gas from a natural gas-burning power plant, etc.). This system also includes a conveyance structure such as a pipe, duct, or conduit, which directs the CO₂-containing multi-component gaseous stream from source 520 to contacting reactor 530 for contacting the multi-component gaseous stream with an aqueous composition. Also illustrated in FIG. 5 is a source of one or more aqueous compositions 510. In some embodiments, the source for one or more aqueous compositions 510 includes a conveyance structure such as a pipe, duct, or conduit, which directs the aqueous composition to the contacting reactor (530). In some instances, the conveyance structure is in fluid communication with a storage basin for storing the aqueous composition. The conduit may be any convenient conduit, such as a pipeline coupled to a pump, e.g., a surface motor turbine pump or subsurface pump.

The aqueous composition provided to the contacting reactor or a component thereof (e.g. gas-liquid contactor, gas-liquid-solid contactor; etc.) may be re-circulated by a recirculation pump such that absorption of the multi-component gaseous stream is optimized within a gas-liquid contactor or gas-liquid-solid contactor within the contacting reactor. With or without recirculation, processors of the invention or a component thereof (e.g. gas-liquid contactor, gas-liquid-solid contactor; etc.) may effect at least 25%, 50%, 70%, or 90% dissolution of the CO₂ in the multi-component gaseous stream. Additional parameters that provide optimal absorption of CO₂ from the multi-component gaseous stream include a specific surface area of 0.1 to 30, 1 to 20, 3 to 20, or 5 to 20 cm⁻¹; a liquid side mass transfer coefficient (k_{L}) of 0.05 to 2, 0.1 to 1, 0.1 to 0.5, or 0.1 to 0.3 cm/s; and a volumetric mass transfer coefficient (k_{L}a) of 0.01 to 10, 0.1 to 8, 0.3 to 6, or 0.6 to 4.0 s⁻¹.

In some embodiments of the invention, contacting reactor 530 may contain or is in operable communication with electrochemical system 535 configured for removing protons from the protonated carbonate composition to produce a deprotonated carbonate composition, as described herein. Where electrochemical system 535 is not disposed within the contacting reactor 530, systems may further include one or more output structures for conveying hydroxide produced by electrochemical system 535 to contacting reactor 530.

In certain embodiments, systems of the invention may also include energy control station 545 having a computer interface to provide a user with collected data from energy monitoring detectors. For example, a detector may determine the energy consumption by the electrochemical system and the computer interface may provide a summary of the amount of energy consumed by the electrochemical system over time. In some embodiments, the energy control station may monitor the energy consumption of the system, such that the energy control station will collect and analyze real-time data (e.g., energy usage from electrochemical system, energy from precipitation reactor etc.) about the energy consumed by the system or collect and provide energy consumption data to the user at regular intervals, e.g., determining energy consumption every 1 minute, every 5 minutes, every 10 minutes, every 30 minutes, every 60 minutes, every 100 minutes, every 200 minutes, every 500 minutes, or some other interval.

In certain embodiments, the energy control station may also include energy regulator 545a, configured to adjust the amount of energy consumed by one or more parts of the system. In embodiments of the invention, the energy regulator can adjust the energy consumption by any part of the system at any time. The energy regulator may employ any convenient protocol to adjust the energy consumption. For example, the energy regulator may employ an electric current control system which is digitally controlled. In some instances, the energy regulator may include a computer interface configured to provide a user with parameters for the system and collected data about the energy consumption by the system. The computer interface may be configured to allow the user to control (i.e., increase or decrease) the energy consumption by any particular component of the system.

Contacting reactor 530 may also include any of a number of different components, including, but not limited to, temperature regulators (e.g., configured to heat the aqueous composition to a desired temperature), pressure regulators, chemical additive components, components for mechanical agitation and/or physical stirring mechanisms; and components for recirculation of industrial plant flue gas through the contacting reactor. Contacting reactor 530 may also contain components configured for monitoring one or more parameters including, but not limited to, pH, metal-ion concentration, conductivity, alkalinity, and pCO₂. Contacting reactor 530 may operate as batch wise, semi-batch wise, or continuously.

Contacting reactor 530 may further include an output conveyance for outputting the reaction products. As discussed above, the produced deprotonated carbonate composition may be further sequestered, such as for example, by conveying the deprotonated carbonate composition into a sequestration location. Alternatively, or in addition to sequestering the deprotonated carbonate composition, the deprotonated carbonate composition may be conveyed to a carbonate-compound production station to produce a carbonate compound precipitation material.

In certain embodiments, systems of the invention may include a mass control station 555, configured to control the amount of the produced deprotonated carbonate composition conveyed to a sequestration location and the amount of the deprotonated carbonate composition conveyed to a carbonate-compound production station. Mass control station 555 may include a set of valves or multi-valve systems which are manually, mechanically or digitally controlled, or may employ any other convenient flow regulator protocol. In some instances, the mass control station may include a computer interface, (where regulation is computer-assisted or is entirely controlled by computer) configured to provide a user with input and output parameters to control the amount of the deprotonated carbonate composition conveyed to the sequestration location or to the carbonate-compound production station. Mass control station 555 may also include one or more input conduits for conveying the deprotonated carbonate composition from contacting reactor 530 to the control station and one or more output conduits for conveying the deprotonated carbonate composition to a sequestration location or to a carbonate-compound production station. In some embodiments, contacting reactor 530 and mass control station 555 are integrated into a single station which can produce the deprotonated carbonate composition as well as regulate the flow of the deprotonated carbonate composition to a sequestration location or to a carbonate-compound production station.

Where some or all of the deprotonated carbonate composition is conveyed to a sequestration location 550, systems of the invention may also include a pumping station 540 for conveying the deprotonated carbonate composition to a sequestration location (e.g., subterranean formation). In some embodiments, pumping station 540 is in fluid communication with mass control station 555, such as by a pipe, duct or conduit which directs the deprotonated carbonate composition from contacting reactor 530 to pumping station 540. The deprotonated carbonate composition provided to pumping station 540 may be conveyed to a sequestration location by gravitational mediated flow or active pumping, as desired. The pumping reactor may employ conventional machinery for actively pumping the bicarbonate composition to the sequestration location, such as for example by down-well turbine-driven motor pumps, geothermal down-well pumps, hydraulic pumps, fluid transfer pumps, surface-located rotary pumps, among other protocols.

Where some or all of the deprotonated carbonate composition is employed to produce a carbonate-containing precipitation material, systems of the invention may also include a carbonate-compound production station 560. In some embodiments, the carbonate-compound production station is in fluid communication with mass control station 555, such as by a pipe, duct or conduit which directs the deprotonated carbonate composition from contacting reactor 530 to carbonate-compound production station 260.

In some instances, carbonate-compound production station 560 may include a source of one or more proton removing agents 560a and a source of one or more divalent cations 560b. As described above, where a portion or all of the deprotonated carbonate composition is bicarbonate, one or more proton removing agents from source 560a may be contacted with the deprotonated carbonate composition prior to contacting the deprotonated carbonate composition with one or more divalent cations from source 560b.

In some instances, carbonate-compound production station 560 may also include one or mores precipitation reactors. The precipitation reactor may also include components for controlling precipitation conditions, such as temperature and pressure regulators and components for mechanical agitation and/or physical stirring mechanisms; and components for recirculation of power plant flue gas through the precipitation reactor. The precipitation reactor may also include output structures for conveying the carbonate-containing precipitation material and depleted aqueous composition from the precipitation reactor. In some embodiments, the deprotonated carbonate composition contacting reactor and precipitation reactor are integrated into a single reactor which contacts the deprotonated carbonate composition with a source of divalent cations and where desired, a source of proton removing agent and produces a a carbonate-containing precipitation material and depleted aqueous composition.

In some embodiments, the carbonate-compound production station may also include a liquid-solid separator for separating carbonate-containing precipitation material from the depleted aqueous composition. In some instances, the liquid-solid separator may be in communication with desalination station 570, configured to produce desalinated water from the liquid product of the liquid-solid separator. System 500 may also include a washer 575 where bulk dewatered precipitation material from the liquid-solid separator is washed (e.g., to remove salts and other solutes from the precipitation material), prior to drying at the drying station 580 (e.g., dryer). The system may further include drying station 580 for drying the carbonate-containing precipitation material from the liquid-solid separator. The dried precipitation material may undergo further processing in refining station 590 in order to obtain desired physical properties. In some embodiments, systems of the invention include a processing station for producing a building material from the carbonate-containing precipitation material. In some instances, the system may be configured to produce a hydraulic cement, a supplementary cementitious material, a pozzolanic cement, or aggregate.

System 500 may further include outlet conveyers (e.g., conveyer belt, slurry pump) configured for removal of precipitation material from one or more of the following: the contacting reactor, precipitation reactor, dryer, washer, or from the refining station. As described in detail herein, precipitation material may be disposed of in a number of different ways. The precipitation material may be transported to a long-term storage site in empty conveyance vehicles (e.g., barges, train cars, trucks, etc.) that may include both above ground and underground storage facilities. In other embodiments, the precipitation material may be disposed of in an underwater location. In some embodiments, the precipitation material may be stored in the same sequestration location as the deprotonated carbonate composition, such as for example, in a subterranean formation. Any convenient conveyance structure for transporting the precipitation material to the site of disposal may be employed. In certain embodiments, a pipeline or analogous slurry conveyance structure may be employed, wherein these structures may include units for active pumping, gravitational mediated flow, and the like.

A person having ordinary skill in the art will appreciate that flow rates, mass transfer, and heat transfer may vary and may be optimized for systems and methods described herein, and that parasitic load on a power plant may be reduced while carbon dioxide separation is maximized.

### Utility

The subject methods and systems find use in separating CO₂ from a multi-component gaseous stream, such as flue gas from natural-gas burning power plant. In some embodiments, the methods and systems are such that the process consumes an amount of energy less than the amount of energy generated by the production of the multi-component gaseous stream. In some embodiments, the subject methods and systems find use in separating carbon dioxide from a multi-component gaseous stream produced by a power plant generating electricity. As processes for separating carbon dioxide from a multi-component gaseous stream generally require significant energy demands, the subject methods and systems find use in processes for separating carbon dioxide from a multi-component gaseous stream from a power plant producing electricity, where the process of separating carbon dioxide from the multi-component gaseous stream consumes less energy than is generated by the power plant to produce the multi-component gaseous stream. As such, separating CO₂ from the multi-component gaseous stream can be accomplished without expending all or more energy than is generated by the power plant. Therefore, energy produced by a power plant in combination with methods of the invention can produce energy while releasing little to no carbon dioxide into the environment.

The subject methods and systems also find use in placement of CO₂ in storage stable form, such as a precipitation material that can be employed in the built environment, e.g., a building, road, dam, levee, foundation, etc. As such, separating CO₂ from the multi-component gaseous stream according to methods of the invention, results in prevention of CO₂ gas from entering the atmosphere. By storage stable form is meant a form of matter that may be stored above ground or underwater under exposed conditions (i.e., open to the atmosphere, underwater environment, etc.) without significant, if any, degradation for extended durations, e.g., 1 year or longer, 5 years or longer, 10 years or longer, 25 years or longer, 50 years or longer, 100 years or longer, 250 years or longer, 1000 years or longer, 10,000 years or longer, 1,000,000 years or longer, or even 100,000,000 years or longer. The above-ground storage stable forms may be storage stable under a variety of different environment conditions, e.g., from temperatures ranging from −100° C. to 600° C., humidity ranging from 0 to 100%, where the conditions may be calm, windy, turbulent or stormy. The below water storage stable forms are similarly stable to with respect to underwater environment conditions.

The subject methods and systems may also be employed to remove gaseous waste products from industrial processes which combust fossil fuels or syngases, e.g., coal, natural gas, oil, used tires, municipal waste, petroleum coke, biofuels, tar sands, oil shale, coal liquids. The subject methods may be practiced in conjunction with the power-producing processes, such as by co-locating or integrating systems of the invention with power generation plants, where some or all of the gaseous waste products from the power plant are separated from the multi-component gaseous stream. Hazardous and toxic pollutants, e.g., NOₓ, SOₓ, volatile organic chemicals, particulates, lead mercury, etc. may be removed from the gaseous emissions in an amount sufficient to reduce or eliminate environmental pollution by the industrial process, and may facilitate improved compliance with regulations by air quality agencies.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the embodiments shown and described herein. Rather, the scope and spirit of present invention is embodied by the appended claims.

That which is claimed is:

1. A method, comprising:
a) contacting a flue gas from a natural gas-burning power plant with an aqueous composition comprising a proton-removing agent under conditions to produce a deprotonated carbonate wherein the natural gas-burning power plant generates 1 ton or less of carbon dioxide per megawatt hour; and
b) producing a carbonate-containing precipitation material from the deprotonated carbonate.

2. The method of claim 1, wherein the natural gas-burning power plant generates 0.1-1 ton of carbon dioxide per megawatt hour.

3. The method of claim 1, wherein the natural gas comprises methane, ethane, butane, propane, or combination thereof.

4. The method of claim 1, further comprising electrochemically producing the proton-removing agent wherein the electrochemical process consumes less energy than an amount of energy generated during production of the flue gas from the natural gas-burning power plant.

5. The method according to claim 4, wherein the electrochemical process runs at a voltage of 1.2 V or less.

6. The method of claim 1, further comprising electrochemically producing the proton-removing agent wherein the electrochemical process comprises contacting an anode with a first electrolyte, contacting a cathode with a second electrolyte, and disposing an ion exchange membrane between the anode and the cathode.

7. The method of claim 6, wherein the electrochemical process comprises producing hydroxide ions in the second electrolyte without forming an oxygen or chlorine gas at the anode.

8. The method of claim 6, wherein the electrochemical process comprises using hydrogen gas at the anode to form hydrogen ions.

9. The method of claim 1, wherein the carbonate-containing precipitation material comprises NaHCO₃, Na₂CO₃, Ca(HCO₃)₂, Mg(HCO₃)₂, CaCO₃, MgCO₃, Na₃(HCO₃)(CO₃), or any combination thereof.

10. The method of claim 1, further comprising processing the carbonate-containing precipitation material to produce a building material selected from the group consisting of hydraulic cement, a supplementary cementitious material, aggregate, and combination thereof.

11. The method of claim 1, wherein the method consumes 70% or less energy than the amount of energy generated during production of the flue gas from the natural gas-burning power plant.

12. The method of claim 1, wherein the method further comprises:
a) determining energy consumption of the method;
b) assessing the determined energy consumption to identify any desired adjustments to the energy consumption; and
c) adjusting the energy consumption of the method based on the assessed energy consumption.

13. A method, comprising: contacting a flue gas from a natural gas-burning power plant with an aqueous composition comprising a proton-removing agent produced by an electrochemical process, wherein the electrochemical process comprises contacting an anode with a hydrogen gas produced from natural gas.

14. The method of claim 13, wherein the method further comprises producing a deprotonated carbonate from the contacting the flue gas from the natural gas-burning power plant with the aqueous composition comprising the proton-removing agent produced by the electrochemical process and producing a carbonate-containing precipitation material from the deprotonated carbonate.

15. A system, comprising:
a) a natural gas-burning source configured to produce power and flue gas wherein the natural gas-burning source generates the flue gas comprising 1 ton or less of carbon dioxide per megawatt hour;
b) a source of one or more aqueous compositions; and
c) one or more reactors operably connected to the sources and configured for contacting the flue gas and the one or more aqueous compositions to produce a protonated carbonate.

16. The system of claim 15, further comprising a source of proton-removing agent operably connected to the source of one or more aqueous compositions or the one or more reactors and configured to deprotonate the protonated carbonate to form deprotonated carbonate.

17. The system of claim 16, wherein the source of the proton-removing agent is an electrochemical system comprising an anode in contact with an anode electrolyte and a cathode in contact with a cathode electrolyte wherein the electrochemical system is configured to form the proton-removing agent in the cathode electrolyte.

18. The system of claim 17, further comprising a hydrogen gas delivery system operably connected to the anode electrolyte configured to deliver hydrogen gas from the natural-gas burning source to the anode wherein the anode is configured to form hydrogen ions from the hydrogen gas.

19. The system of claim 17, further comprising a contactor operably connected to the cathode electrolyte and configured to contact the flue gas with the cathode electrolyte.

20. The system of claim 17, further comprising a carbonate-compound production station configured to produce a carbonate-containing precipitation material from the deprotonated carbonate.
